(19) United States
(12) Patent Application Publication
(10) Pub. No.: US 2020/0142102 A1
(43) Pub. Date: May 7, 2020

(54) HARD COAT FILM SUPPRESSED IN CURLING AND METHOD FOR PRODUCING SAME

(71) Applicant: DAICEL CORPORATION, Osaka-shi, Osaka (JP)

(72) Inventor: Shinji KIKUCHI, Himeji-shi (JP)

(73) Assignee: DAICEL CORPORATION, Osaka-shi, Osaka (JP)

(21) Appl. No.: 16/607,503

(22) PCT Filed: May 11, 2018
(86) PCT No.: PCT/JP2018/018328

§ 371 Date: Oct. 23, 2019

(30) Foreign Application Priority Data
May 12, 2017 (JP) 2017-095633

(51) Int. Cl. G02B 1/14; C09D 183/04; C08J 5/12; C08J 5/18; B32B 7/12; B32B 27/36

(52) U.S. Cl. CPC G02B 1/14; C09D 183/04; C08J 5/12; C08J 5/18; C08G 77/70; B32B 27/36; C08J 2367/00; C08J 2483/04; B32B 7/12

(57) ABSTRACT

The purpose of the present invention is to provide a hard coat film that suppresses curling, exhibits high surface hardness (preferably excellent pliability and bendability (flexibility)), and can be subjected to processing treatments such as bonding and edge printing. The present invention provides a hard coat film (1) that includes a base material (5) and a hard coat layer (4) formed on one surface of the base material (5); wherein an adhesive layer (3) and a surface protection film (2) are laminated in this order on the surface of the hard coat layer (4); the hard coat layer (4) is formed of a cured product of a curable composition, and the curable composition contains a curable compound having a curing expansion property; and the surface protection film (2) has an internal residual stress (6) that is compressible with respect to the hard coat layer (4). The present invention also provides a method for producing the hard coat film (1).

### TECHNICAL FIELD

The present invention relates to a hard coat film with suppressed curling and a method for producing the same. More specifically, the present invention relates to a hard coat film having a base material and a hard coat layer on one surface of the base material, an adhesive layer and a surface protection film being laminated in this order on a surface of the hard coat layer, and also relates to a method for producing the same. The present application claims priority from JP 2017-095633 filed in Japan on May 12, 2017, the content of which is incorporated herein.

### BACKGROUND ART

In the related art, hard coat films having a hard coat layer on one or both sides of a base material, in which the hard coat layer surface has a pencil hardness of approximately 3H, have been commonly used. UV acrylic monomers have been primarily used as the material for forming the hard coat layer in such a hard coat film (for example, see Patent Document 1). However, hard coat films, etc. in which the abovementioned UV acrylic monomers are used cannot yet be said to have sufficient surface hardness.

There have been examples in which nanoparticles have been added to the hard coat layer to further improve the hardness of the hard coat layer surface. However, when nanoparticles are added to the hard coat layer, the nanoparticles exhibiting poor compatibility with the UV acrylic monomer aggregate and result in a problem of the hard coat layer whitening.

Generally, in order to further increase the hardness of the hard coat layer surface, a method of polyfunctionalizing the UV acrylic monomer to increase the crosslinking density and thickening the hard coat layer is conceivable. However, in a case where such a method is used, a problem is that the curing shrinkage of the hard coat layer becomes large, and as a result, curling occurs (hereinafter, sometimes referred to as “forward curling”), in which the surface on which the hard coat layer of the hard coat film is formed becomes concave. When a circular polarizing plate is bonded to the hard coat film or when edge printing or other such processing treatment is performed, the processing itself becomes difficult if excessive curling is generated, and therefore, a hard coat film having a high surface hardness with suppressed curling is in demand.

A conceivable method for preventing forward curling of the hard coat film is to provide a hard coat layer having the same composition on both sides of the base material with the same thickness to thereby offset the curing shrinkage. However, when the hard coat layer is provided on both sides, costs are elevated, and the total thickness increases, which leads to problems such as a reduction in bendability or a decrease in optical characteristics such as transparency.

On the other hand, glass is known as a material having a very high surface hardness without the problem of curling, and in particular, it is known that the surface hardness is increased to a pencil hardness of 9H through an alkali ion exchange treatment. However, in the alkali ion exchange treatment of glass, a large amount of alkaline waste liquid is generated, and results in a problem of a large environmental load. As additional problems, glass cannot be produced or processed with a roll-to-roll process due to drawbacks of being heavy and brittle and having little flexibility and processability, and therefore glass must be produced or processed in sheets, resulting in high production costs.

In optical films having a functional layer such as a hard coat layer and an anti-glare layer, as a method for suppressing forward curling caused by curing shrinkage of the functional layer, a method of applying tension to the optical film and, while doing so, affixing a surface protection film, to which a lower level of tension is imparted than that of the optical film, to the functional layer side is known (for example, see Patent Document 2).

### CITATION LIST

### Patent Document

Patent Document 1: JP 2009-279840 A

Patent Document 2: JP 2013-11774 A

### SUMMARY OF INVENTION

### Technical Problem

In the method described in Patent Document 2, when the optical film is a hard coat film, a larger forward curling is generated when the crosslinking density is increased to improve the surface hardness, and therefore, a stronger tension must be applied to the optical film in order to suppress this forward curling. However, ordinarily a relationship exists such that pliability and bendability (flexibility) decrease as the surface hardness of the hard coat film increases and that the hard coat film becomes brittle. Therefore, applying a strong tension to suppress the forward curling of a hard coat film with increased surface hardness results in problems including the generation of cracks in the hard coat layer and a decrease in optical characteristics such as transparency. In addition, with the method of Patent Document 2, tension is imparted to the optical film by applying a difference in circumferential speeds between rolls in production with a roll-to-roll process. However, when the surface hardness of the hard coat film is increased, the bendability (flexibility) is reduced, and production with the roll-to-roll process itself becomes difficult.

Thus, currently, there is no hard coat film that suppresses curling and excels in surface hardness, pliability, and bendability (flexibility).

Therefore, an object of the present invention is to provide a hard coat film that suppresses curling, exhibits high surface hardness (preferably excellent pliability and bendability (flexibility)), and can be subjected to processing treatments such as bonding and edge printing.

### Solution to Problem

The present inventors discovered that when curling in which the hard coat layer side of the hard coat film becomes convex (hereinafter, may be referred to as “reverse curling” in the present specification) is generated by adopting, as a component of a curable composition constituting the hard coat layer, a curable compound having a property of expanding in volume when cured (curing expansion property), the reverse curling is effectively suppressed by bonding, to the hard coat layer, a surface protection film to which a stronger tension than that of the hard coat film is applied. According to this method, tension is substantially not applied to the hard coat layer, or only a very weak tension is applied thereto, and therefore the present inventors successfully provided a hard coat film in which curling (reverse curling) is effectively suppressed without the occurrence of cracking even if the surface hardness is increased and which has a high surface hardness and can be subjected to processing treatments such as bonding and edge printing.

A hard coat layer formed using, as a curable compound having a curing expansion property, a cationic curable silicone resin containing a silsesquioxane unit having an epoxy group has excellent pliability and bendability (flexibility) while also exhibiting high surface hardness. Despite the high surface hardness of the hard coat layer, the method described above can be performed with a roll-to-roll process, and a hard coat film in which curling is suppressed, which exhibits high surface hardness, pliability and bendability and which can be subjected to bonding, edge printing, and other such processing treatments, can be efficiently produced.

The present invention was achieved based on these findings.

That is, the present invention provides a hard coat film, the hard coat film including a base material; and a hard coat layer formed on one surface of the base material; wherein

an adhesive layer and a surface protection film are laminated in this order on the surface of the hard coat layer;

the hard coat layer is formed of a cured product of a curable composition, and the curable composition contains a curable compound having a curing expansion property; and

the surface protection film has an internal residual stress that is compressible with respect to the hard coat layer.

With respect to the hard coat film, preferably, the curable compound having a curing expansion property includes a cationic curable silicone resin, the cationic curable silicone resin includes a silsesquioxane unit, and a ratio of monomer units having an epoxy group to all monomer units is 50 mol % or greater.

With respect to the hard coat film, the surface protection film may include a polyester resin.

The hard coat film may include, as the silsesquioxane unit, a constituent unit represented by Formula (1) below, and a ratio of constituent units represented by Formula (1) with respect to a total amount of siloxane constituent units (100 mol %) is 50 mol % or greater.

[Chem. 1]

[R¹SiO_{3/2}] (1)

(In Formula (1), R¹ denotes: a group containing an epoxy group; a hydrogen atom; or a hydrocarbon group.)

The hard coat film may further include, as the silsesquioxane unit, a constituent unit represented by Formula (2) below, and a molar ratio of the constituent unit represented by Formula (1) to the constituent unit represented by Formula (2) (constituent unit represented by Formula (1))/(constituent unit represented by Formula (2)) is 5 or greater.

[Chem. 2]

[R¹SiO_{2/2}(OR²)] (2)

(In Formula (2), R¹ is the same as in Formula (1), and R² denotes a hydrogen atom or an alkyl group having from 1 to 4 carbons atoms.)

With respect to the hard coat film, a total ratio (total amount) of the constituent units represented by Formula (1) and the constituent units represented by Formula (2) with respect to a total amount (100 mol %) of the siloxane constituent units may be from 55 to 100 mol %.

In the hard coat film, the number average molecular weight of the cationic curable silicone resin may be from 1000 to 3000.

In the hard coat film, a molecular weight dispersity (weight average molecular weight)/(number average molecular weight) of the cationic curable silicone resin may be from 1.0 to 3.0.

In the hard coat film, R¹ in Formula (1) may contain at least one group represented by Formulas (1a) to (1d) below.

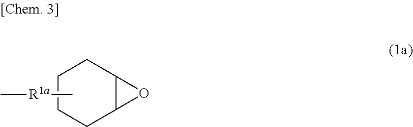

(In Formula (1a), R^{1a} denotes a linear or branched alkylene group.)

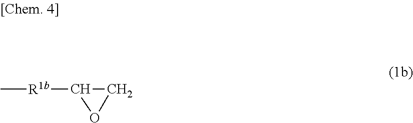

(In Formula (1b), R^{1b} denotes a linear or branched alkylene group.)

### [Chem. 5]

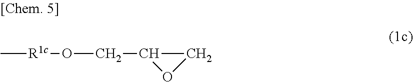

(In Formula (1c), R^{1c} denotes a linear or branched alkylene group.)

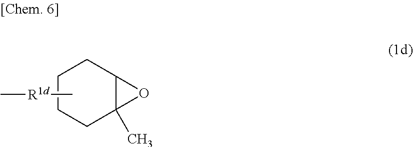

(In Formula (1d), R^{1d} denotes a linear or branched alkylene group.)

In the hard coat film, the curable composition may further include a curing catalyst.

In the hard coat film, the curing catalyst may be a photocationic polymerization initiator.

In the hard coat film, the curing catalyst may be a thermal cationic polymerization initiator.

In the hard coat film, a thickness of the hard coat layer may be from 10 to 40 μm.

In the hard coat film, a thickness of the base material may be from 25 to 80 μm.

The present invention also provides a method for producing a hard coat film by bonding a below-described hard coat layer of a below-described first film to a below-described adhesive layer of a below-described second film,

a first film having a base material and a hard coat layer formed on one surface of the base material, wherein the hard coat layer is formed of a cured product of a curable composition, and the curable composition contains a curable compound having a curing expansion property,

a second film having a surface protection film and an adhesive layer formed on one surface of the surface protection film;

the production method for the hard coat film including:

conveying the first film and the second film in a state of being respectively tensioned, such that the hard coat layer of the first film and the adhesive layer of the second film are mutually facing; and

bonding the hard coat layer of the first film to the adhesive layer of the second film; wherein

the tension imparted to the second film is greater than the tension imparted to the first film.

With respect to the method for producing a hard coat film, preferably, the curable compound having a curing expansion property includes a cationic curable silicone resin, the cationic curable silicone resin includes a silsesquioxane unit, and a ratio of monomer units having an epoxy group to all monomer units is 50 mol % or greater.

The method for producing a hard coat film may be performed with a roll-to-roll process.

In the method for producing a hard coat film, tension may be imparted in the machine flow directions (MD direction) of the first film and the second film.

### Advantageous Effects of Invention

The hard coat film of the present invention, by virtue of having the configuration described above such that curling is suppressed and the hard coat film has high surface hardness, is suitable as a hard coat film that can be subjected to processing treatments such as edge printing and bonding of circular polarizing plates. Furthermore, with the hard coat film production method of the present invention, substantially no tension or only a very weak tension is applied to the hard coat layer, and therefore cracks are not produced even when the surface hardness is increased. Moreover, the hard coat layer formed by curing a curable composition containing a specific cationic curable silicone resin excels in pliability and bendability (flexibility) and does not require the application of strong tension, and therefore, the hard coat layer can be efficiently produced with a roll-to-roll process.

### BRIEF DESCRIPTION OF DRAWINGS

FIG. 1 is a cross-sectional schematic view illustrating an example of a preferable aspect of the hard coat film of the present invention.

FIG. 2 is a cross-sectional schematic view illustrating an example of a preferable aspect (in-line process) of the hard coat film production method of the present invention.

FIG. 3 is a cross-sectional schematic view illustrating an example of a preferable aspect (roll-to-roll process) of the hard coat film production method of the present invention.

FIG. 4 is a schematic view for explaining a method for evaluating and testing curling in an embodiment.

### DESCRIPTION OF EMBODIMENTS

### Hard Coat Film

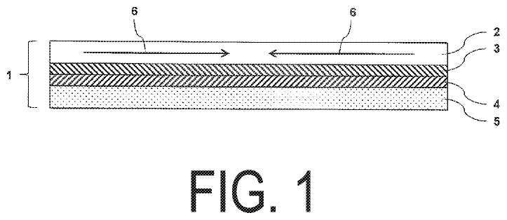

The hard coat film according to an embodiment of the present invention (hereinafter, also simply referred to as the “present invention”) has a base material and a hard coat layer formed on one surface of the base material, and an adhesive layer and a surface protection film are laminated in this order on the surface of the hard coat layer. A cross-sectional schematic view (base material layer/hard coat layer/adhesive layer/surface protection film) of one example of a preferable aspect of the hard coat film of the present invention is illustrated in FIG. 1. In addition to the base material layer, hard coat layer, adhesive layer, and surface protection film, the hard coat film of the present invention may also include an anchor layer, an adhesive layer other than the adhesive layer, a low reflection layer, an stain-repellent layer, a water-repellent layer, an oil repellent layer, an anti-fogging layer, a protection film layer other than the surface protection film, a printed layer, a conductive layer, an electromagnetic wave shielding layer, a UV light absorbing layer, an infrared light absorbing layer, and a blue light cutting layer. The hard coat film of the present invention can be fabricated by the hard coat film production method described below. In addition, the hard coat layer may be formed on only a part of the surface of the base material layer, or may be formed on the entire surface thereof. The hard coat film of the present invention may be a hard coat sheet.

The thickness of the hard coat film (total thickness of the base material layer/hard coat layer/adhesive layer/surface protection film layer) of the present invention can be appropriately selected from a range from, for example, 1 to 10000 μm, preferably from 10 to 1000 μm, more preferably from 15 to 800 μm, even more preferably from 20 to 700 μm, and particularly preferably from 30 to 500 μm.

The haze of the hard coat film of the present invention is, for example, 1.5% or less and preferably 1.0% or less. In addition, the lower limit of the haze is, for example, 0.1%. When the haze is set particularly to 1.0% or less, the hard coat film of the present invention tends to be suitable for use, for example, in applications requiring very high transparency (for example, a surface protection sheet of a display of a touch panel or the like). The haze of the hard coat film according to an embodiment of the present invention can be easily controlled to the above range by, for example, using a transparent base material described below as the base material. Here, the haze can be measured according to JIS K7136.

The total light transmittance of the hard coat film according to an embodiment of the present invention is, for example, 85% or greater and preferably 90% or greater. In addition, the upper limit of the total light transmittance is, for example, 99%. When the total light transmittance is set particularly to 90% or greater, the hard coat film of the present invention tends to be suitable for use, for example, in applications requiring very high transparency (for example, in a surface protection sheet of a display of a touch panel or the like). The total light transmittance of the hard coat film according to an embodiment of the present invention can be easily controlled to the above range by, for example, using a below-described transparent base material as the base material. Here, the total light transmittance can be measured according to JIS K7361-1.

In the hard coat film of the present invention, reverse curling caused by curing expansion of the hard coat layer is effectively suppressed. In the hard coat film of the present invention, the curling amount (curling in normal conditions) evaluated in the examples described below is preferably 30 mm or less and more preferably 10 mm or less, from the perspective of being able to perform a processing treatment such as edge printing and bonding of a circular polarizing plate. Furthermore, from the perspective of being able to suitably perform a heating treatment, the curling when heated at 120° C. is preferably 35 mm or less and more preferably 15 mm or less.

### Hard Coat Layer

In the present invention, the hard coat layer is formed from a cured product of the curable composition described below. The hard coat layer is a hard coat layer (cured product layer of a curable composition) formed using a curable composition (hard coat layer forming curable composition). Note that the hard coat layer can be fabricated from the curable composition using a first film production method (hard coat layer forming step) described below.

From the perspectives of surface hardness and scratch resistance, the thickness of the hard coat layer is, for example, from 1 to 100 μm, preferably from 2 to 80 μm, more preferably from 3 to 60 μm, even more preferably from 5 to 50 μm, and most preferably from 10 to 40 μm. In a case where the thickness of the hard coat layer is thinner than 1 μm, it may not be possible to maintain high surface hardness in some cases. In addition, in a case where the thickness of the hard coat layer is greater than 100 μm, curing expansion is increased, and problems such as larger reverse curling tend to more easily occur.

The pencil hardness of the hard coat layer surface is not particularly limited and is preferably H or greater, more preferably 2H or greater, even more preferably 3H or greater, particularly preferably 4H or greater, and most preferably 6H or greater. Here, the pencil hardness can be evaluated according to the method described in JIS K5600-5-4.

For cases in which the thickness of the hard coat layer is 50 μm, the haze of the hard coat layer is, for example, 1.5% or less and preferably 1.0% or less. In addition, the lower limit of the haze is, for example, 0.1%. When the haze is set particularly to 1.0% or less, the hard coat film of the present invention tends to be suitable for use, for example, in applications requiring very high transparency (for example, a surface protection sheet of a display of a touch panel or the like). Here, the haze of the hard coat layer can be measured according to JIS K7136.

In cases where the thickness of the hard coat layer is 50 μm, the total light transmittance of the hard coat layer is, for example, 85% or greater and preferably 90% or greater. In addition, the upper limit of the total light transmittance is, for example, 99%. A hard coat layer with a total light transmittance of 85% or greater tends to be suitable for use, for example, in applications requiring very high transparency (for example, in a surface protection sheet of a display of a touch panel or the like). Here, the total light transmittance of the hard coat layer of the present invention can be measured according to JIS K7361-1.

The scratch resistance of the hard coat layer surface is ordinarily high and, for example, is such that scratches do not occur even when #0000 steel wool with a diameter of 1 cm is slid (rubbed) back and forth across the surface 100 times with a load of 1 kg/cm².

The hard coat layer also excels in surface smoothness, and when measured according to JIS B0601, the arithmetic mean roughness Rₐ is, for example, from 0.1 to 20 nm, preferably from 0.1 to 10 nm, and more preferably from 0.1 to 5 nm.

The hard coat layer also exhibits excellent surface slipperiness (stain repellency), and the water contact angle of the surface is, for example, 600 or greater (for example, from 60 to 1100), preferably from 70 to 1100, and more preferably from 80 to 1100. When the water contact angle is 60° or greater, the hard coat layer excels in both slipperiness (stain repellency) and scratch resistance.

### Curable Composition

The curable composition of the present invention includes a curable compound having a curing expansion property. The curable composition according to an embodiment of the present invention includes a curable compound having a curing expansion property, and thus a below-described first film undergoes reverse curling in which the hard coat layer becomes convex.

In the present invention, the “curable compound having a curing expansion property” means a compound in which the volume of the cured product obtained by subjecting the curable compound to a curing treatment increases (expands) compared to that of the uncured product. The volume expansion percentage of such a compound having a curing expansion property is not particularly limited but is normally, for example, from 0.01 to 30% and preferably from 0.01 to 10%, based on the uncured product. When the volume expansion percentage exceeds 30%, problems such as intense reverse curling of the first film due to curing expansion may occur.

In the present invention, the volume expansion percentage of the curable compound having a curing expansion property can be calculated by the following method. Namely, a liquid resin composition containing a polymerization initiator and the curable compound having a curing expansion property is prepared, a film formed from the resin composition is cured by UV irradiation or heating to form a cured film, and a specific gravity x of the resin composition before curing and a specific gravity y of the cured film are obtained. When a value obtained by substituting these values into the equation {[(y−x)/×]×100} is negative, the compound can be confirmed to be a compound having a curing expansion property. The absolute value of the negative value calculated by the above equation can be used as the volume expansion percentage.

The curable compound having the curing expansion property of the present invention is not particularly limited, and for example, a cationic polymerizable compound having a curing expansion property as disclosed in JP 2008-238417 A, the silicone compounds described in JP 2003-292892 A and JP 2007-217704 A, etc. can be used without limitation. However, from the perspective of being able to form a cured product (hard coat layer) having high surface hardness and excellent pliability, bendability (flexibility), and processability, a cationic curable silicone resin having a curing expansion property (sometimes referred to simply as a “cationic curable silicone resin” hereafter) is preferable.

In addition to the curable compound having the curing expansion property, the curable composition of the present invention may also contain an epoxy compound other than the cationic curable silicone resin (hereinafter, also simply referred to as an “epoxy compound”), a silicon acrylate, silica particles having a group containing a (meth)acryloyl group on the surface, and a curing catalyst. The most preferable aspect of the curable composition of the present invention includes a cationic curable silicone resin as a curable compound having a curing expansion property, an epoxy compound, a silicon acrylate, silica particles having a group containing a (meth)acryloyl group on the surface, and a curing catalyst. An aspect including a cationic curable silicone resin as a curable compound having a curing expansion property is described, but the present invention is not limited thereto.

### Cationic Curable Silicone Resin

The abovementioned cationic curable silicone resin contains a silsesquioxane unit as a unit constituting a monomer, and the ratio of monomer units having an epoxy group in all monomer units is not less than 50 mol %.

The cationic curable silicone resin preferably has a constituent unit represented by Formula (1) below (sometimes referred to as a “T3 form”) as a silsesquioxane unit.

[Chem. 7]

[R¹SiO_{3/2}] (1)

The constituent unit represented by Formula (1) above is a silsesquioxane constituent unit (so-called “T unit”) generally represented by [RSiO_{3/2}]. Here, R in the above formula represents a hydrogen atom or a monovalent organic group and is also the same below. The constituent unit represented by Formula (1) above is formed by subjecting a corresponding hydrolyzable trifunctional silane compound (specifically, a compound represented by Formula (a) described below) to hydrolysis and a condensation reaction.

R¹ in Formula (1) denotes a group (monovalent group) containing an epoxy group; a hydrogen atom; or a hydrocarbon group (monovalent group). Examples of the group containing an epoxy group include known and commonly used groups having an oxirane ring, and examples thereof include a group containing a glycidyl group or a group containing an alicyclic epoxy group.

Examples of the group containing a glycidyl group include glycidyloxy C₁₋₁₀ alkyl groups (particularly glycidyloxy C₁₋₄ alkyl groups) such as a glycidyloxy methyl group, a 2-glycidyloxy methyl group, and a 3-glycidyloxy methyl group.

The group containing an alicyclic epoxy group is not particularly limited and may be an epoxy C₅₋₁₂ cycloalkyl linear or branched C₁₋₁₀ alkyl group, for example, an epoxycyclopentyl C₁₋₁₀ alkyl group such as a 2,3-epoxycyclopentyl methyl group, a 2-(2,3-epoxycyclopentyl)ethyl group, and a 3-(2,3-epoxycyclopentyl)propyl group; an epoxycyclooctyl C₁₋₁₀ alkyl group such as a 4,5-epoxycyclooctyl methyl group, a 2-(4,5-epoxycyclooctyl)ethyl group, and a 3-(4,5-epoxycyclooctyl)propyl group.

These groups containing an alicyclic epoxy group may have, as a substituent in a C₅₋₁₂ cycloalkane ring, a C₁₋₄ alkyl group such as a methyl group or an ethyl group. Examples of groups containing an alicyclic epoxy group having a substituent include C₁₋₄ alkyl-epoxy C₅₋₁₂ cycloalkyl-linear or branched C₁₋₁₀ alkyl groups such as a 4-methyl-3,4-epoxycyclohexyl methyl group, a 2-(3-methyl-3,4-epoxycyclohexyl) ethyl group, a 2-(4-methyl-3,4-epoxycyclohexyl) ethyl group, a 3-(4-methyl-3,4-epoxycyclohexyl) propyl group, 4-(4-methyl-3,4-epoxycyclohexyl) butyl group.

As the group containing a glycidyl group or the group containing an alicyclic epoxy group, from the perspectives of curability of the curable composition and the surface hardness and heat resistance of the cured product, groups represented by Formulas (1a) to (1d) below are preferable, groups represented by Formulas (1a) and (1c) below are more preferable, and a group represented by Formula (1a) below is even more preferable.

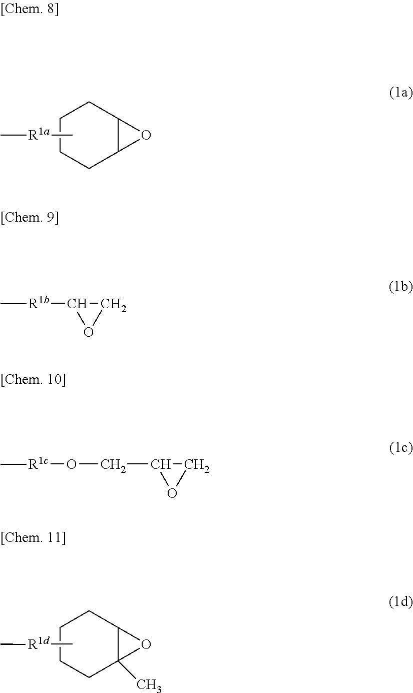

In Formula (1a) above, R^{1a} denotes a linear or branched alkylene group. Examples of the linear or branched alkylene group include linear or branched alkylene groups having from 1 to 10 carbon atoms, such as a methylene group, a methyl methylene group, a dimethyl methylene group, an ethylene group, a propylene group, a trimethylene group, a tetramethylene group, a pentamethylene group, a hexamethylene group, and a decamethylene group. Among these, from the perspectives of surface hardness and curability of the cured product, R^{1a} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

In Formula (1b) above, R^{1b} denotes a linear or branched alkylene group, and examples include the same groups as those of R^{1a}. Among these, from the perspectives of surface hardness and curability of the cured product, R^{1b} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

In Formula (1c) above, R^{1c} denotes a linear or branched alkylene group, and examples include the same groups as R^{1a}. Among these, from the perspectives of surface hardness and curability of the cured product, R^{1c} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

In Formula (1d) above, R^{1d} denotes a linear or branched alkylene group, and examples include the same groups as R^{1a}. Among these, from the perspectives of surface hardness and curability of the cured product, R^{1d} is preferably a linear alkylene group having from 1 to 4 carbon atoms or a branched alkylene group having 3 or 4 carbon atoms, more preferably an ethylene group, a trimethylene group, or a propylene group, and even more preferably an ethylene group or a trimethylene group.

R¹ in Formula (1) is particularly preferably a group represented by Formula (1a) in which R^{1a} is an ethylene group (among which a 2-(3′,4′-epoxycyclohexyl)ethyl group is particularly preferable).

Examples of the hydrocarbon group that is the R¹ in Formula (1) include an alkyl group, an alkenyl group, a cycloalkyl group, a cycloalkenyl group, an aryl group, and an aralkyl group. Examples of the alkyl group include linear or branched alkyl groups such as a methyl group, an ethyl group, a propyl group, an n-butyl group, an isopropyl group, an isobutyl group, an s-butyl group, a t-butyl group, and an isopentyl group. Examples of the alkenyl group include linear or branched alkenyl groups such as a vinyl group, an allyl group, and an isopropenyl group. Examples of the cycloalkyl group include a cyclobutyl group, a cyclopentyl group, and a cyclohexyl group. Examples of the cycloalkenyl group include a cyclopentenyl group, a cyclohexenyl group, and a cycloheptanyl group. Examples of the aryl group include a phenyl group, a tolyl group, and a naphthyl group. Examples of the aralkyl group include a benzyl group and a phenethyl group.

These hydrocarbon groups may have substituents, and the substituents may be these hydrocarbon groups, such as an ether group, an ester group, a carbonyl group, a siloxane group, a halogen atom, a (meth)acrylic group, a mercapto group, an amino group, or a hydroxyl group.

The cationic curable silicone resin may include only one type of constituent unit represented by Formula (1) above or may include two or more types of constituent units represented by Formula (1) above.

Generally, a complete cage-type silsesquioxane is formed of only the constituent unit represented by Formula (1) above (“T3 form”), but the above cationic curable silicone resin preferably further contains a constituent unit represented by Formula (2) below (sometimes referred to as a “T2 form”). An incomplete cage-type silsesquioxane can be formed by including a specific ratio of the T2 form to the T3 form in the curable composition described above, and therefore the hardness of the cured product can be improved.

[Chem. 12].

[R¹SiO_{2/2}(OR²)] (2)

R¹ in Formula (2) denotes, similar to Formula (1) above, a group (monovalent group) containing an epoxy group; a hydrogen atom; or a hydrocarbon group (monovalent group), and in Formula (2), a group containing an epoxy group and a hydrocarbon group that are preferable in Formula (2) are also the same as in Formula (1). R² in Formula (2) denotes a hydrogen atom or a C₁₋₄ alkyl group. Examples of the C₁₋₄ alkyl group of R² include a methyl group, an ethyl group, a propyl group, or a butyl group, and among these, a methyl group and an ethyl group (and particularly a methyl group) are preferable.

The ratio [T3 form/T2 form] of the constituent unit (T3 form) represented by Formula (1) above to the constituent unit (T2 form) represented by Formula (2) above in the cationic curable silicone resin is, for example, 5 or greater, preferably from 5 to 18, more preferably from 6 to 16, and even more preferably from 7 to 14. When the [T3 form/T2 form] ratio described above is 5 or greater, the surface hardness and adhesiveness of the cured product and hard coat layer are significantly improved.

The [T3 form/T2 form] ratio in the silsesquioxane unit of the above-described cationic curable silicone resin can be determined, for example, through ²⁹Si-NMR spectral measurements. In the ²⁹Si-NMR spectrum, the silicon atom in the constituent unit (T3 form) represented by Formula (1) above and the silicon atom in the constituent unit (T2 form) represented by formula (2) above exhibit signals (peaks) at different positions (chemical shifts), and thus the above ratio [T3 form/T2 form] is determined by calculating the integration ratio of these respective peaks. Specifically, for example, when the silsesquioxane unit includes a constituent unit represented by Formula (1) above where R¹ is a 2-(3′,4′-epoxycyclohexyl)ethyl group, the signal of the silicon atom in the structure (T3 form) represented by Formula (1) above appears at −64 to −70 ppm, and the signal of the silicon atom in the structure (T2 form) represented by Formula (2) above appears at −54 to −60 ppm. Thus, in this case, the above ratio [T3 form/T2 form] can be determined by calculating the integration ratio of the signal at −64 to −70 ppm (T3 form) and the signal at −54 to −60 ppm (T2 form). A ratio [T3 form/T2 form] of the silsesquioxane unit of 5 or greater means that a certain amount or greater of T2 forms are present relative to T3 forms.

The ²⁹Si-NMR spectrum of the cationic curable silicone resin can be measured, for example, with the following instrument and conditions.

Measuring instrument: Trade name “JNM-ECA500NMR” (available from JEOL Ltd.)

Solvent: Deuterochloroform

Number of integration times: 1800 times

Measurement temperature: 25° C.

The silsesquioxane unit of the cationic curable silicone resin is confirmed to have a cage-type (incomplete cage-type) silsesquioxane structure by an FT-IR spectrum in which the cationic curable silicone resin has no inherent absorption peaks around 1050 cm⁻¹ and 1150 cm¹ each but has one inherent absorption peak around 1100 cm⁻¹[Reference Document: R. H. Raney, M. Itoh, A. Sakakibara and T. Suzuki, Chem. Rev. 95, 1409 (1995)]. In contrast, if inherent absorption peaks are present around 1050 cm⁻¹ and 1150 cm⁻¹ respectively in the FT-IR spectrum, the silsesquioxane unit of the cationic curable silicone resin is typically identified as having a ladder-type silsesquioxane structure. The FT-IR spectrum can be measured, for example, with the following instrument and conditions.

Measuring instrument: Trade name “FT-720” (available from Horiba, Ltd.)

Measurement method: Transmission method

Resolution: 4 cm⁻¹

Measurement wavenumber range: from 400 to 4000 cm⁻¹

Number of integration times: 16 times

The cationic curable silicone resin may include a constituent unit represented by Formula (1) above as a silsesquioxane unit but may be a combination of a constituent unit represented by Formula (3) below and a constituent unit represented by Formula (4) below. In Formula (3), R³ is a group containing an alicyclic epoxy group, and in Formula (4), R⁴ is an aryl group that may have a substituent.

[Chem. 13]

[R³SiO_{3/2}] (3)

[Chem. 14]

[R⁴SiO_{3/2}] (4)

The cationic curable silicone resin may further include as a silsesquioxane unit, in addition to the constituent units (T units) represented by Formula (1) and Formula (2) above, at least one type of siloxane constituent unit selected from the group consisting of, as other monomer units (silsesquioxane constituent units), a constituent unit represented by monofunctional [(R¹)₃SiO_{1/2}] (“M unit”); a constituent unit represented by bifunctional [(R¹)₂SiO_{2/2}] (“D unit”); and a constituent unit represented by tetrafunctional [SiO_{4/2}] (“Q unit”). Note that, in the M unit and D unit, the group represented by R¹ is the same as in Formula (1) above.

The ratio of monomer units having an epoxy group with respect to the total amount of siloxane constituent units [total siloxane constituent units: total amount of M units, D units, T units, and Q units] in the cationic curable silicone resin is 50 mol % or greater (from 50 to 100 mol %), preferably from 55 to 100 mol %, more preferably from 65 to 99.9 mol %, even more preferably from 80 to 99 mol %, and particularly preferably from 90 to 99 mol %. In a case where the ratio of monomer units having an epoxy group is too small, the surface hardness of the cured product decreases.

The ratio of constituent units (T3 form) expressed by Formula (1) above with respect to the total amount (100 mol %) of siloxane constituent units [total siloxane constituent units: total amount of M units, D units, T units, and Q units] in the cationic curable silicone resin described above is, for example, 50 mol % or greater (from 50 to 100 mol %), preferably from 60 to 99 mol %, more preferably from 70 to 98 mol %, even more preferably from 80 to 95 mol %, and particularly preferably from 85 to 92 mol %. If the ratio is less than 50 mol %, it is difficult to form an incomplete cage shape having an appropriate molecular weight, and there is a concern that the surface hardness of the cured product may decrease.

The ratio (total amount) of the constituent units (T3 form) represented by formula (1) above to the constituent units (T2 form) represented by Formula (2) above, per a total amount (100 mol %) of siloxane constituent units (total siloxane constituent units: total amount of M units, D units, T units, and Q units) in the cationic curable silicone resin is, for example, from 55 to 100 mol %, preferably from 65 to 100 mol %, and more preferably from 80 to 99 mol %. When the above ratio is 55 mol % or greater, the curability of the curable composition improves, and the surface hardness and adhesiveness of the cured product significantly increase.

The number average molecular weight (Mn) of the above cationic curable silicone resin obtained through GPC in terms of standard polystyrene is not particularly limited but is, for example, from 1000 to 3000, preferably from 1000 to 2800, and more preferably from 1100 to 2600. Setting the number average molecular weight to 1000 or higher further improves the heat resistance, scratch resistance, and adhesiveness of the cured product. On the other hand, setting the number average molecular weight to not greater than 3000 improves compatibility with other components in the curable composition and further improves the heat resistance of the cured product.

The molecular weight dispersity (Mw/Mn) of the above cationic curable silicone resin obtained through GPC in terms of standard polystyrene is not particularly limited but is, for example, from 1.0 to 3.0, preferably from 1.1 to 2.0, more preferably from 1.2 to 1.9, and even more preferably from 1.45 to 1.8. When the molecular weight dispersity is set to 3.0 or less, the surface hardness and adhesiveness of the cured product are further increased. On the other hand, when the molecular weight dispersity is set to 1.0 or greater, the cationic curable silicone resin easily becomes a liquid, and the handling ease tends to improve.

Note that the number average molecular weight and molecular weight dispersity above are values in terms of standard polystyrene obtained through gel permeation chromatography (GPC) and more specifically, can be measured with the following instrument and conditions.

Measuring instrument: Trade name “LC-20AD” (available from Shimadzu Corporation)

Column: Shodex KF-801×quantity of 2, KF-802, and KF-803 (available from Showa Denko K.K.)

Measurement temperature: 40° C.

Eluent: THF, sample concentration of 0.1 to 0.2 wt. %

Flow rate: 1 mL/min

Detector: UV-VIS detector (trade name “SPD-20A”, available from Shimadzu Corporation)

Molecular weight: in terms of standard polystyrene

A 5% weight loss temperature (T_{d5}) of the cationic curable silicone resin in an air atmosphere is, for example, 330° C. or higher (for example, from 330 to 450° C.), preferably 340° C. or higher, and more preferably 350° C. or higher. When the 5% weight loss temperature is 330° C. or higher, there is a tendency for the heat resistance of the cured product to further improve. In particular, when the cationic curable silicone resin is such that the above ratio [T3 form/T2 form] is 5 or greater, the number average molecular weight is from 1000 to 3000, the molecular weight dispersity is from 1.0 to 3.0, and one inherent peak is present around 1100 cm¹ in the FT-IR spectrum, the 5% weight loss temperature thereof can be controlled to 330° C. or higher. Here, the 5% weight loss temperature is a temperature at which 5% of the weight before heating decreases when heated at a constant temperature increase rate and is an indicator of heat resistance. The 5% weight loss temperature can be measured by thermogravimetric analysis (TGA) under conditions of a temperature increase rate of 5° C./min in an air atmosphere.

The content amount (compounded amount) of the cationic curable silicone resin in the curable composition is, for example, from 70 wt. % to less than 100 wt. %, preferably from 80 to 99.8 wt. %, and more preferably from 90 to 99.5 wt. %, per a total amount of the curable composition excluding the solvent. Setting the content amount of the cationic curable silicone resin to 70 wt. % or greater tends to further improve the surface hardness and adhesiveness of the cured product. On the other hand, when the content amount of the cationic curable silicone resin is set to less than 100 wt. %, a curing catalyst can be included, and thereby curing of the curable composition tends to proceed more efficiently.

The ratio of the cationic curable silicone resin to the total amount (100 wt %) of the cationic curable compound contained in the curable composition is, for example, from 70 to 100 wt. %, preferably from 75 to 98 wt. %, and more preferably from 80 to 95 wt. %. Setting the content amount of the cationic curable silicone resin to 70 wt. % or greater tends to further improve the surface hardness and adhesiveness of the cured product.

### Method for Producing a Cationic Curable Silicone Resin

The cationic curable silicone resin can be produced by a known and commonly used method for producing a polyorganosiloxane and, for example, can be produced by a method of hydrolysis and condensation of one or more types of hydrolyzable silane compounds. As the hydrolyzable silane compound, however, a hydrolyzable trifunctional silane compound (compound represented by Formula (a) below) for forming a constituent unit represented by Formula (1) described above must be used as an essential hydrolyzable silane compound.

More specifically, for example, the cationic curable silicone resin can be produced by a method of hydrolysis and condensation of a compound represented by Formula (a) below (hydrolyzable trifunctional silane compound), which is a hydrolyzable silane compound for forming a silsesquioxane constituent unit (T unit) in the cationic curable silicone resin.

[Chem. 15]

R¹Si(X¹)₃ (a)

The compound represented by Formula (a) above is a compound that forms a constituent unit represented by Formula (1) above. R¹ in Formula (a) is the same as R¹ in Formula (1) and denotes a group (monovalent group) containing an epoxy group; a hydrogen atom; or a hydrocarbon group (monovalent group). That is, R¹ in Formula (a) is preferably a group represented by Formulas (1a) to (1d) above, is more preferably a group represented by Formulas (1a) and (1c) above, is even more preferably a group represented by Formula (1a) above, and is particularly preferably a group represented by Formula (1a) above in which R^{1a} is an ethylene group (among which a 2-(3′,4′-epoxycyclohexyl)ethyl group).

X¹ in Formula (a) above denotes an alkoxy group or a halogen atom. Examples of the alkoxy group of X¹ include alkoxy groups having from 1 to 4 carbon atoms, such as a methoxy group, an ethoxy group, a propoxy group, an isopropyloxy group, a butoxy group, and an isobutyloxy group. In addition, examples of the halogen atom of X¹ include a fluorine atom, a chlorine atom, a bromine atom, and an iodine atom. Among these, X¹ is preferably an alkoxy group and more preferably a methoxy group or an ethoxy group. In addition, the three X¹s each may be the same or different.

A hydrolyzable trifunctional silane compound other than the compound represented by Formula (a) above may be used in combination in the cationic curable silicone resin. Examples of the hydrolyzable trifunctional silane compound other than the compound represented by Formula (a) above include a hydrolyzable monofunctional silane compound [(R¹)₃SiX¹] that forms an M unit, a hydrolyzable bifunctional silane compound [(R¹)₂Si(X¹)₂] that forms a D unit, and a hydrolyzable tetrafunctional silane compound [Si(X¹)₄] that forms a Q unit. Note that R¹ and X¹ in these monomers are the same as those in formula (a).

The usage amount and composition of the hydrolyzable silane compound can be suitably adjusted in accordance with the structure of the desired cationic curable silicone resin. For example, the usage amount of the compound represented by Formula (a) above is from 55 to 100 mol %, preferably from 65 to 100 mol %, and more preferably from 80 to 99 mol %, per a total amount (100 mol %) of the hydrolyzable silane compound that is used.

In addition, in a case where two or more types of the hydrolyzable silane compounds are used in combination, hydrolysis and condensation reactions of these hydrolyzable silane compounds can be performed simultaneously or sequentially. The order of the reactions when performed sequentially is not particularly limited.

The hydrolysis and condensation reactions of the hydrolyzable silane compound can be performed in the presence or absence of a solvent. Among these options, the hydrolysis and condensation reactions are preferably performed in the presence of a solvent. Examples of the solvent include aromatic hydrocarbons, such as benzene, toluene, xylene, and ethylbenzene; ethers, such as diethyl ether, dimethoxyethane, tetrahydrofuran, and dioxane; ketones, such as acetone, methyl ethyl ketone, and methyl isobutyl ketone; esters, such as methyl acetate, ethyl acetate, isopropyl acetate, and butyl acetate; amides, such as N,N-dimethylformamide and N,N-dimethylacetamide; nitriles, such as acetonitrile, propionitrile, and benzonitrile; and alcohols, such as methanol, ethanol, isopropyl alcohol, and butanol. Among these, the solvent is preferably a ketone or ether. In addition, one type of the solvent can be used alone, or two or more types thereof can be used in combination.

The usage amount of the solvent is not particularly limited and can be appropriately adjusted in a range from 0 to 2000 parts by weight, per 100 parts by weight of a total amount of the hydrolyzable silane compound, according to the desired reaction time and the like.

The hydrolysis and condensation reactions of the hydrolyzable silane compound are preferably performed in the presence of a catalyst and water. The catalyst may be an acid catalyst or an alkali catalyst. Examples of the acid catalyst include mineral acids, such as hydrochloric acid, sulfuric acid, nitric acid, phosphoric acid, and boric acid; phosphates; carboxylic acids, such as acetic acid, formic acid, and trifluoroacetic acid; sulfonic acids, such as methanesulfonic acid, trifluoromethanesulfonic acid, and p-toluenesulfonic acid; solid acids, such as activated clay; and Lewis acids, such as iron chloride. Examples of the alkali catalyst include alkali metal hydroxides, such as lithium hydroxide, sodium hydroxide, potassium hydroxide, and cesium hydroxide; alkaline earth metal hydroxides, such as magnesium hydroxide, calcium hydroxide, and barium hydroxide; alkali metal carbonates, such as lithium carbonate, sodium carbonate, potassium carbonate, and cesium carbonate; alkaline earth metal carbonates, such as magnesium carbonate; alkali metal hydrogencarbonates, such as lithium hydrogencarbonate, sodium hydrogencarbonate, potassium hydrogencarbonate, and cesium hydrogencarbonate; alkali metal organic acid salts (for example, acetates), such as lithium acetate, sodium acetate, potassium acetate, and cesium acetate; alkaline earth metal organic acid salts (for example, acetates), such as magnesium acetate; alkali metal alkoxides, such as lithium methoxide, sodium methoxide, sodium ethoxide, sodium isopropoxide, potassium ethoxide, and potassium t-butoxide; alkali metal phenoxides, such as sodium phenoxide; amines (tertiary amines, etc.), such as triethylamine, N-methylpiperidine, 1,8-diazabicyclo[5.4.0]undec-7-ene, and 1,5-diazabicyclo[4.3.0]non-5-ene; and nitrogen-containing heterocyclic aromatic compounds, such as pyridine, 2,2′-bipyridyl, and 1,10-phenanthroline. Here, one type of the catalyst can be used alone, or two or more types thereof can be used in combination. In addition, the catalyst can be used in a state of being dissolved or dispersed in water, a solvent, or the like.

The usage amount of the catalyst is not particularly limited and can be appropriately adjusted in a range from 0.002 to 0.200 mol per a total amount of 1 mol of the hydrolyzable silane compound.

The amount of water used during the hydrolysis and condensation reactions is not particularly limited and can be appropriately adjusted in a range from 0.5 to 20 mol per a total amount of 1 mol of the hydrolyzable silane compound.

The method for adding water is not particularly limited, and the total amount (total usage amount) of water to be used may be added all at once or may be added sequentially. When water is added sequentially, it may be added continuously or intermittently.

The reaction temperature of the hydrolysis and condensation reactions is, for example, from 40 to 100° C. and preferably from 45 to 80° C. By controlling the reaction temperature to the above range, the above ratio [T3 form/T2 form] tends to be more efficiently controlled to 5 or greater. In addition, the reaction time of the hydrolysis and condensation reactions is, for example, from 0.1 to 10 hours and preferably from 1.5 to 8 hours. Furthermore, the hydrolysis and condensation reactions can be performed under normal pressure or can be performed under increased pressure or reduced pressure. Here, the hydrolysis and condensation reactions may be performed, for example, in any of an inert gas atmosphere such as a nitrogen atmosphere or an argon atmosphere or the presence of oxygen, such as the air. However, the hydrolysis and condensation reactions are preferably performed in an inert gas atmosphere.

The cationic curable silicone resin can be obtained by hydrolysis and condensation reactions of the hydrolyzable silane compound. After completion of the hydrolysis and condensation reactions, the catalyst is preferably neutralized to prevent the ring-opening of the epoxy group. The cationic curable silicone resin of an embodiment of the present invention may be separated and refined by a separation technique, such as washing with water, acid washing, alkali washing, filtration, concentration, distillation, extraction, crystallization, recrystallization, and column chromatography, and a separation technique that combines these.

### Epoxy Compound

The curable composition may contain an epoxy compound other than the cationic curable silicone resin. A cured product having a high surface hardness and excellent pliability, flexibility, and processability can be formed by including, in the curable composition, an epoxy compound in addition to the cationic curable silicone resin described above.

The epoxy compound is not particularly limited, and a known and commonly used compound having one or more epoxy groups (oxirane rings) in the molecule can be used. Examples thereof include alicyclic epoxy compounds (alicyclic epoxy resins), aromatic epoxy compounds (aromatic epoxy resins), and aliphatic epoxy compounds (aliphatic epoxy resins). Among these, alicyclic epoxy compounds are preferable.

The alicyclic epoxy compound is not particularly limited, and examples include known and commonly used compounds having one or more alicyclic rings and one or more epoxy groups in the molecule. Examples thereof include (1) a compound having an epoxy group (referred to as an “alicyclic epoxy group”) constituted of two adjacent carbon atoms and an oxygen atom that constitute an alicyclic ring in the molecule; (2) a compound in which an epoxy group is directly bonded to an alicyclic ring with a single bond; and (3) a compound having an alicyclic ring and a glycidyl ether group in the molecule (a glycidyl ether type epoxy compound).

The compound (1) having an alicyclic epoxy group in the molecule can be optionally selected and used from known and commonly used compounds. Among these, the alicyclic epoxy group is preferably a cyclohexene oxide group and particularly preferably a compound represented by Formula (i) below.

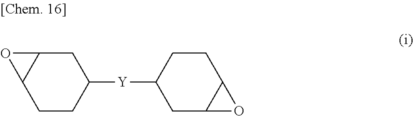

In Formula (i) above, Y denotes a single bond or a linking group (a divalent group having one or more atoms). Examples of the linking group include divalent hydrocarbon groups, alkenylene groups in which some or all of the carbon-carbon double bonds are epoxidized, carbonyl groups, ether bonds, ester bonds, carbonate groups, amide groups, and groups in which a plurality thereof are linked.

Examples of the divalent hydrocarbon group include linear or branched alkylene groups having from 1 to 18 carbon atoms; and divalent alicyclic hydrocarbon groups. Examples of the linear or branched alkylene group having from 1 to 18 carbon atoms include a methylene group, a methyl methylene group, a dimethyl methylene group, an ethylene group, a propylene group, and a trimethylene group. Examples of the divalent alicyclic hydrocarbon group include divalent cycloalkylene groups (including a cycloalkylidene group), such as a 1,2-cyclopentylene group, a 1,3-cyclopentylene group, a cyclopentylidene group, a 1,2-cyclohexylene group, a 1,3-cyclohexylene group, a 1,4-cyclohexylene group, and a cyclohexylidene group.

Examples of the alkenylene group of the alkenylene group in which some or all of the carbon-carbon double bonds are epoxidized (the alkenylene group thereof may be referred to as an “epoxidized alkenylene group”) include a linear or branched alkenylene group having from 2 to 8 carbon atoms, such as a vinylene group, a propenylene group, a 1-butenylene group, a 2-butenylene group, a butadienylene group, a pentenylene group, a hexenylene group, a heptenylene group, and an octenylene group. In particular, the epoxidized alkenylene group is preferably an alkenylene group in which all of the carbon-carbon double bonds are epoxidized; and more preferably an alkenylene group having from 2 to 4 carbon atoms in which all of the carbon-carbon double bonds are epoxidized.

Representative examples of the alicyclic epoxy compound represented by formula (i) above include (3,4,3′,4′-diepoxy)bicyclohexyl and compounds represented by Formulas (i-1) to (i-10) below. In Formulas (i-5) and (i-7) below, l and m each denote an integer from 1 to 30. R′ in formula (i-5) below is an alkylene group having from 1 to 8 carbon atoms, and among these, a linear or branched alkylene group having from 1 to 3 carbon atoms, such as a methylene group, an ethylene group, a propylene group, or an isopropylene group, is preferred. In formulas (i-9) and (i-10) below, n1 to n6 each represent an integer from 1 to 30. In addition, examples of the alicyclic epoxy compound represented by formula (i) above include 2,2-bis(3,4-epoxycyclohexyl)propane, 1,2-bis(3,4-epoxycyclohexyl)ethane, 2,3-bis(3,4-epoxycyclohexyl)oxirane, and bis(3,4-epoxycyclohexylmethyl)ether.

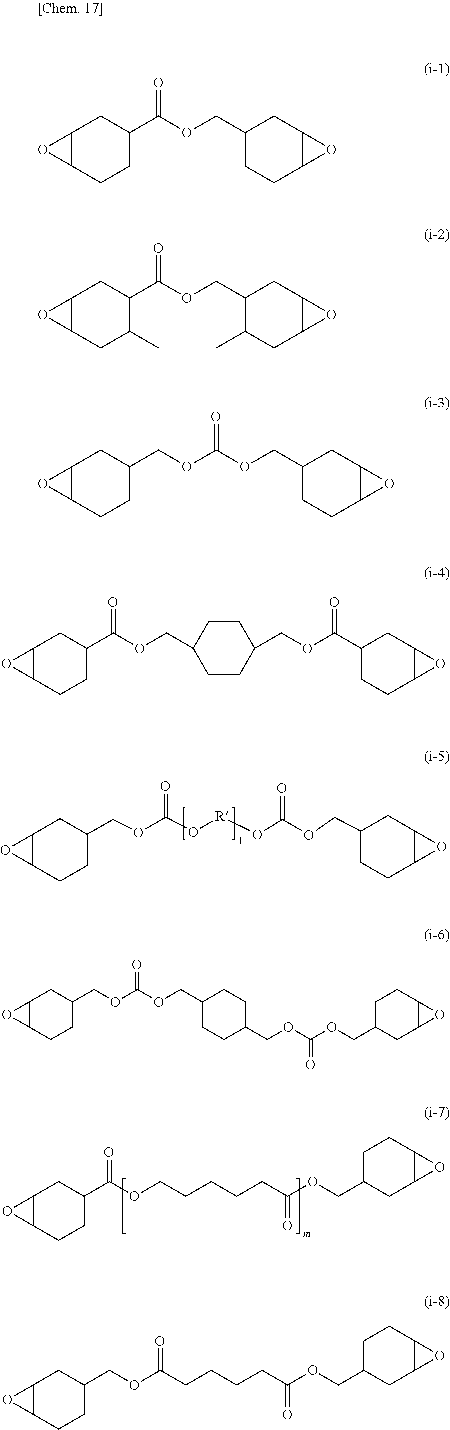

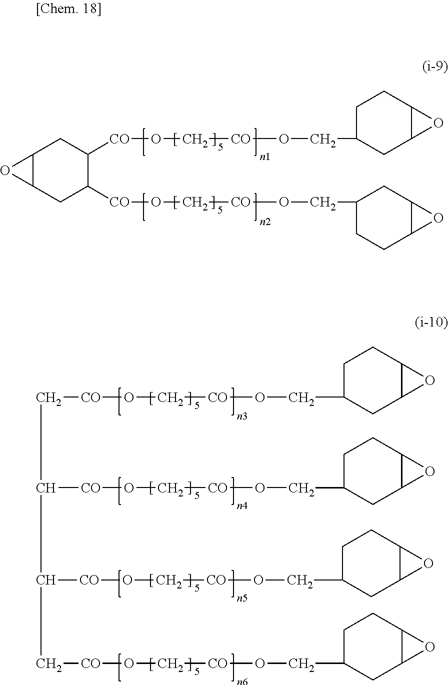

Examples of the compound (2) described above in which an epoxy group is directly bonded to an alicyclic ring with a single bond include a compound represented by Formula (ii) below.

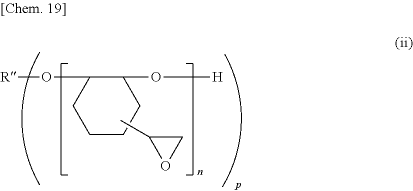

In Formula (ii), R″ is a group (p-valent organic group) resulting from elimination of a quantity of p hydroxyl groups (—OH) from a structural formula of a p-hydric alcohol, wherein p and n each represent a natural number. Examples of the p-hydric alcohol [R″(OH)ₚ] include polyhydric alcohols (alcohols having from 1 to 15 carbon atoms, etc.), such as 2,2-bis(hydroxymethyl)-1-butanol. Here, p is preferably from 1 to 6, and n is preferably from 1 to 30. When p is 2 or greater, n in each group in parentheses (in the outer parentheses) may be the same or different. Examples of the compound represented by formula (ii) specifically include a 1,2-epoxy-4-(2-oxiranyl)cyclohexane adduct (for example, product of the trade name “EHPE3150” (available from Daicel Corporation), etc.) of 2,2-bis(hydroxymethyl)-1-butanol.

Examples of the above-described compound (3) having an alicyclic ring and a glycidyl ether group in the molecule include glycidyl ethers of alicyclic alcohols (in particular, alicyclic polyhydric alcohols). More specific examples thereof include a compound obtained by hydrogenating a bisphenol A type epoxy compound (a hydrogenated bisphenol A type epoxy compound), such as 2,2-bis[4-(2,3-epoxypropoxy)cyclohexyl]propane and 2,2-bis[3,5-dimethyl-4-(2,3-epoxypropoxy)cyclohexyl]propane; a compound obtained by hydrogenating a bisphenol F type epoxy compound (a hydrogenated bisphenol F type epoxy compound), such as bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, and bis[3,5-dimethyl-4-(2,3-epoxypropoxy)cyclohexyl]methane; a hydrogenated bisphenol type epoxy compound; a hydrogenated phenol novolac type epoxy compound; a hydrogenated cresol novolac type epoxy compound; a hydrogenated cresol novolac type epoxy compound of bisphenol A; a hydrogenated naphthalene type epoxy compound; a hydrogenated epoxy compound of an epoxy compound obtained from trisphenolmethane; and a hydrogenated epoxy compound of an aromatic epoxy compound described below.

Examples of the aromatic epoxy compound include an epibis type glycidyl ether type epoxy resin obtained by a condensation reaction of bisphenols (for example, bisphenol A, bisphenol F, bisphenol S, and fluorenebisphenol, etc.) and an epihalohydrin; a high molecular weight epibis type glycidyl ether type epoxy resin obtained by further subjecting the above epibis type glycidyl ether type epoxy resin to an addition reaction with the bisphenol described above; a novolac alkyl type glycidyl ether type epoxy resin obtained by subjecting a phenol (for example, phenol, cresol, xylenol, resorcin, catechol, bisphenol A, bisphenol F, and bisphenol S, etc.) and an aldehyde (for example, formaldehyde, acetaldehyde, benzaldehyde, hydroxybenzaldehyde, and salicylaldehyde, etc.) to a condensation reaction to obtain a polyhydric alcohol and then further subjecting the polyhydric alcohol to condensation reaction with epihalohydrin; and an epoxy compound in which two phenol skeletons are bonded at the 9-position of the fluorene ring and in which glycidyl groups are each bonded directly or via an alkyleneoxy group to an oxygen atom resulting from eliminating a hydrogen atom from a hydroxy group of these phenol skeletons.

Examples of the aliphatic epoxy compound include glycidyl ethers of a q-hydric alcohol not having a cyclic structure (q is a natural number); glycidyl esters of monovalent or polyvalent carboxylic acids (for example, acetic acid, propionic acid, butyric acid, stearic acid, adipic acid, sebacic acid, maleic acid, and itaconic acid, etc.); epoxidized materials of oils and fats having a double bond, such as epoxidized linseed oil, epoxidized soybean oil, and epoxidized castor oil; and epoxidized materials of polyolefins (including polyalkadienes), such as epoxidized polybutadiene. Here, examples of the q-hydric alcohol not having a cyclic structure include monohydric alcohols, such as methanol, ethanol, 1-propyl alcohol, isopropyl alcohol, and 1-butanol; dihydric alcohols, such as ethylene glycol, 1,2-propanediol, 1,3-propanediol, 1,4-butanediol, neopentyl glycol, 1,6-hexanediol, diethylene glycol, triethylene glycol, tetraethylene glycol, dipropylene glycol, polyethylene glycol, and polypropylene glycol; and trihydric or higher polyhydric alcohols, such as glycerin, diglycerin, erythritol, trimethylolethane, trimethylolpropane, pentaerythritol, dipentaerythritol, and sorbitol. In addition, the q-hydric alcohol may be a polyether polyol, a polyester polyol, a polycarbonate polyol, a polyolefin polyol, or the like.

The content amount (compounded amount) of the epoxy compound is, for example, from 0.5 to 100 parts by weight, preferably from 1 to 80 parts by weight, and more preferably from 5 to 50 parts by weight, per the total amount of 100 parts by weight of the cationic curable silicone resin. The surface hardness of the cured product becomes higher, and the pliability, flexibility, and processability tend to become more excellent by setting the content amount of the epoxy compound to 0.5 parts by weight or greater. On the other hand, setting the content amount of the epoxy compound to not greater than 100 parts by weight tends to further improve the scratch resistance of the cured product.

### Silicon Acrylate

The curable composition according to an embodiment of the present invention may include a silicon acrylate (silicone acrylate). The silicon acrylate is a type of additive including at least a silicon atom and a (meth)acryloyl group. The silicon acrylate may include a functional group besides the (meth)acryloyl group (for example, a hydroxyl group). The silicon acrylate may be silicon diacrylate, silicon triacrylate, silicon tetraacrylate, silicon pentaacrylate, silicon hexacrylate, silicon heptaacrylate, or silicon octaacrylate. When the silicon acrylate is used in a curable composition together with the cationic curable silicone resin, the silicon acrylate exhibits properties of being able to effectively increase the crosslinking density of the cured product layer surface of the resulting cured product, improve the appearance, such as surface smoothness, of the cured product (in particular, the hard coat layer), and improve the surface hardness, scratch resistance, and stain repellency. Note that the term (meth)acryloyl group is a generic term for an acryloyl group (acrylic group) and a methacryloyl group (methacrylic group).

The silicon acrylate may be used in a dispersion liquid (dispersion) in a state of being dispersed in a known or commonly used typical dispersion medium, such as an organic solvent (for example, acetone, toluene, methanol, and ethanol). As the silicon acrylate, for example, a product of the trade names “KRM8479”, “EBECRYL 350”, and “EBECRYL 1360” (available from Daicel-Allnex Ltd.) can be used.

When the curable composition of the present invention contains the silicon acrylate, the ratio of the silicon acrylate is, for example, from 0.01 to 15 parts by weight, preferably from 0.05 to 10 parts by weight, more preferably from 0.01 to 5 parts by weight, and even more preferably from 0.2 to 3 parts by weight, per 100 parts by weight of the cationic curable silicone resin. Setting the ratio of the silicon acrylate to 0.01 parts by weight or greater can improve the scratch resistance and stain repellency of the resulting cured product (in particular, the hard coat layer). In addition, setting the ratio of the silicon acrylate to 15 parts by weight or less can further increase the surface hardness of the resulting cured product.

### Silica Particles Having a Group Containing a (Meth)acryloyl Group on Surface)

The curable composition according to an embodiment of the present invention may include silica particles having a group containing a (meth)acryloyl group on the surface. In the silica particles, an infinite number of hydroxyl groups (Si—OH groups) are present on the surface of the silica particles, and by the hydroxyl groups react with the cationic curable silicone resin during curing, the crosslinking density of the cationic curable silicone resin after curing improves. In addition, (meth)acryloyl groups in a plurality of the silica particles bind to each other during curing, thereby improving the crosslinking density after curing. By improving the crosslinking density after curing in this manner, the silica particles have properties of further improving the scratch resistance and appearance such as the smoothness of the surface of the cured product (particularly the hard coat layer). The silica particles may include, on the surface thereof, a functional group besides a (meth)acryloyl group (for example, a silicone-modified group). Note that the term (meth)acryloyl group is a generic term for an acryloyl group (acrylic group) and a methacryloyl group (methacrylic group).

The silica particles may be used in a dispersion liquid (dispersion) in a state of being dispersed in a known or commonly used typical dispersion medium, such as water and organic solvents. In addition, silica particles that have reacted with a silane coupling agent having a group containing a (meth)acryloyl group may be used as the silica particles. As the silica particles, for example, silica particles of the trade names “BYK-LPX 22699”, “NANOBYK-3650”, “NANOBYK-3651”, and “NANOBYK-3652” (all available from BYK Japan KK) can be used.

The particle size of the silica particles is, for example, from 1 to 100 nm, preferably from 3 to 50 nm, and more preferably from 5 to 30 nm.

When the curable composition contains silica particles having a group containing a (meth)acryloyl group on the surface thereof, the ratio of the silica particles thereof is, for example, from 0.01 to 20 parts by weight, preferably from 0.05 to 15 parts by weight, more preferably from 0.01 to 10 parts by weight, and even more preferably from 0.2 to 5 parts by weight, per 100 parts by weight of the cationic curable silicone resin. When the ratio of silica particles is set to 0.01 parts by weight or greater, the surface appearance of the cured product (in particular, the hard coat layer) can be improved. In addition, setting the ratio of the silica particles to 20 parts by weight or less can increase the surface hardness of the cured product.

From the perspectives of further improving the appearance of the cured product (in particular, the hard coat layer), increasing the surface hardness, and improving the scratch resistance, preferably both a silicon acrylate; and silica particles having a group containing a (meth)acryloyl group on the surface are used in the curable composition according to an embodiment of the present invention. When the curable composition contains both a silicon acrylate and the silica particles, the ratio of the total of the silicon acrylate and the silica particles is, for example, from 0.01 to 20 parts by weight, preferably from 0.05 to 15 parts by weight, more preferably from 0.01 to 10 parts by weight, and even more preferably from 0.2 to 5 parts by weight, per 100 parts by weight of the cationic curable silicone resin. When the above ratio is set to 0.01 parts by weight or greater, the scratch resistance of the resulting cured product (in particular, the hard coat layer) can be improved. In addition, when the above ratio is set to 20 parts by weight or less, the surface hardness of the resulting cured product can be further increased.

### Leveling Agent

The curable composition may contain a leveling agent to improve the surface smoothness. As the leveling agent, any commonly used leveling agent can be used as long as the leveling agent is able to reduce surface tension. From the perspective of excelling in a surface tension reducing capability, the leveling agent is preferably a silicone-based leveling agent or a fluorine-based leveling agent, and a silicone-based leveling agent is particularly preferable. In the present invention, surface smoothness can be enhanced, and transparency, glossiness (appearance), and slipperiness, etc. can be improved by combining the cationic curable silicone resin with a leveling agent. Furthermore, surface hardness and scratch resistance can be further improved by using a specific amount of a specific leveling agent.

The silicone leveling agent is a leveling agent containing a compound having a polysiloxane backbone, and the polyorganosiloxane backbone may be, similar to the cationic curable silicone resin described above, any polyorganosiloxane backbone as long as it is formed with an M unit, a D unit, a T unit, and a Q unit, but ordinarily, a polyorganosiloxane formed with a D unit is preferably used. As the organic group of the polyorganosiloxane, a C₁₋₄ alkyl group or aryl group is typically used, and a methyl group or a phenyl group (particularly a methyl group) is commonly used. The number of repetitions (degree of polymerization) of the siloxane unit is, for example, from 2 to 3000, preferably from 3 to 2000, and more preferably from 5 to 1000.

The fluorine-based leveling agent is a leveling agent having a fluoroaliphatic hydrocarbon backbone, and examples of the fluoroaliphatic hydrocarbon backbone include fluoro C₁₋₁₀ alkanes such as fluoromethane, fluoroethane, and fluoropropane, fluoroisopropane, flourobutane, fluoroisobutane, fluoro-t-butane, fluoropentane, and fluorohexane.

Any of these fluoroaliphatic hydrocarbon backbones may be used as long as at least some of the hydrogen atoms are replaced with fluorine atoms, but from the perspective of improving scratch resistance, slipperiness, and stain repellency, a perfluoro-aliphatic hydrocarbon backbone in which all of the hydrogen atoms have been replaced with fluorine atoms is preferable.

Furthermore, the fluoroaliphatic hydrocarbon backbone may form a polyfluoroalkylene ether backbone, which is a repeating unit through an ether bond. The fluoroaliphatic hydrocarbon group as a repeating unit may be at least one type selected from the group consisting of fluoro C₁₋₄ alkylene groups such as fluoromethylene, fluoroethylene, fluoropropylene, and fluoroisopropylene. The number of repetitions (degree of polymerization) of the polyfluoroalkylene ether unit is, for example, from 10 to 3000, preferably from 30 to 1000, and more preferably from 50 to 500.

Of these backbones, a polyorganosiloxane backbone is preferable because of the excellent affinity with the cationic curable silicone resin.

The leveling agent having such a skeleton may have a functional group such as a hydrolytically condensable group, a group that is reactive with an epoxy group, a radical polymerizable group, a polyether group, a polyester group, or a polyurethane group in order to impart various functionalities. Furthermore, the silicone-based leveling agent may have a fluoroaliphatic hydrocarbon group, and the fluorine-based leveling agent may have a polyorganosiloxane group.

Examples of the hydrolytically condensable group include a trihalosilyl group such as a hydroxysilyl group and a trichlorosilyl group; a dihalo C₁₋₄ alkylsilyl group such as a dichloromethyl silyl group; a dihalo aryl group such as a dichlorophenyl silyl group; a halo di-C₁₋₄ alkylsilyl group such as a chloro di-C₁₋₄ alkylsilyl group such as a chlorodimethyl silyl group; tri-C₁₋₄ alkoxysilyl group such as a trimethoxysilyl group and a triethoxysilyl group; a di-C₁₋₄ alkoxy C₁₋₄ alkylsilyl group such as a dimethoxy methyl silyl group and a diethoxy methyl silyl group; a di-C₁₋₄ alkoxy arylsilyl group such as a dimethoxy phenylsilyl group and a diethoxy phenylsilyl group; a C₁₋₄ alkoxy di-C₁₋₄ alkylsilyl such as a methoxy dimethylsilyl group and an ethoxy dimethylsilyl group; a C₁₋₄ alkoxy diarylsilyl group such as a methoxy diphenylsilyl group and an ethoxy diphenylsilyl group; and a C₁₋₄ alkoxy C₁₋₄ alkylaryl silyl group such as a methoxy methylphenylsilyl group and an ethoxy methylphenylsilyl group. Among these, from perspectives such as reactivity, a tri-C₁₋₄ alkoxysilyl group such as a trimethoxysilyl group is preferable.

Examples of the group that is reactive with respect to the epoxy group include a hydroxyl group, an amino group, a carboxyl group, an acid anhydride group (such as a maleic anhydride group), and an isocyanate group. Among these, from perspectives of reactivity and the like, hydroxyl groups, amino groups, acid anhydride groups, and isocyanate groups, etc. are widely used, and hydroxyl groups are preferable from perspectives such as handling ease and procurement ease.

Examples of the radical polymerizable group include (meth)acryloyloxy groups and vinyl groups. Of these, (meth)acryloyloxy groups are widely used.

Examples of the polyether group include a polyoxy C₂₋₄ alkylene group such as polyoxyethylene groups, polyoxypropylene groups, polyoxybutylene, and polyoxyethylene-polyoxypropylene groups. In the polyether group, the number of repetitions (number of added moles) of oxyalkylene groups is, for example, from 2 to 1000, preferably from 3 to 100, and more preferably from 5 to 50. Among these, a polyoxy C₂₋₃ alkylene group (particularly polyoxyethylene group) such as polyoxyethylene and polyoxypropylene is preferable.

Examples of the polyester group include polyester groups formed by a reaction between a dicarboxylic acid (an aromatic carboxylic acid, such as terephthalic acid, or an aliphatic carboxylic acid, such as adipic acid, etc.) and a diol (an aliphatic diol such as ethylene glycol, etc.); and polyester groups formed through ring-opening polymerization of a cyclic ester (for example, lactones such as caprolactone).

Examples of the polyurethane group include commonly used polyester-type polyurethane groups; and polyether-type polyurethane groups.

These functional groups may be directly bonded and introduced to the polyorganosiloxane backbone or to the fluoroaliphatic hydrocarbon backbone and may be introduced via a linking group (for example, an alkylene group, a cycloalkylene group, an ether group, an ester group, an amide group, a urethane group, a linking group that is a combination of these, or the like).

Among these functional groups, from the perspective of improving the hardness of the cured product by reacting with the cationic curable silicone resin, a hydrolytically condensable group or a group that is reactive with an epoxy group is preferable, and a group (particularly a hydroxyl group) that is reactive with an epoxy group is particularly preferable.

Note that the hydroxyl group may be a terminal hydroxyl group of a (poly)oxyalkylene group (such as a (poly)oxyethylene group). Examples of such leveling agents include silicone leveling agents (such as polydimethylsiloxane polyoxyethylene) in which a (poly)oxy C₂₋₃ alkylene group such as a (poly)oxyethylene group is introduced to a side chain of a polyorganosiloxane backbone such as polydimethylsiloxane; and a fluorine-based leveling agent (such as fluoroalkyl polyoxyethylene) in which a fluoroaliphatic hydrocarbon group is introduced to a side chain of a (poly)oxy C₂₋₃ alkylene backbone such as (poly)oxyethylene.

Commercially available silicone-based leveling agents can be used as the silicone-based leveling agent. For example, commercially available products under the trade names “BYK-300”, “BYK-301/302”, “BYK-306”, “BYK-307”, “BYK-310”, “BYK-315”, “BYK-313”, “BYK-320”, “BYK-322”, “BYK-323”, “BYK-325”, “BYK-330”, “BYK-331”, “BYK-333”, “BYK-337”, “BYK-341”, “BYK-344”, “BYK-345/346”, “BYK-347”, “BYK-348”, “BYK-349”, “BYK-370”, “BYK-375”, “BYK-377”, “BYK-378”, “BYK-UV3500”, “BYK-UV3510”, “BYK-UV3570”, “BYK-3550”, “BYK-SILCLEAN 3700”, and “BYK-SILCLEAN 3720” (all above available from BYK Japan KK); the trade names “AC FS 180”, “AC FS 360”, and “AC S 20” (all above available from Algin Chemie); the trade names “POLYFLOW KL-400X”, “POLYFLOW KL-400HF”, “POLYFLOW KL-401”, “POLYFLOW KL-402”, “POLYFLOW KL-403”, and “POLYFLOW KL-404” (all above available from Kyoeisha Chemical Co., Ltd.); the trade names “KP-323”, “KP-326”, “KP-341”, “KP-104”, “KP-110”, and “KP-112” (all above available from Shin-Etsu Chemical Co., Ltd.); and the trade names “LP-7001”, “LP-7002”, “8032 ADDITIVE”, “57 ADDITIVE”, “L-7604”, “FZ-2110”, “FZ-2105”, “67 ADDITIVE”, “8618 ADDITIVE”, “3 ADDITIVE”, and “56 ADDITIVE” (all above available from Dow Corning Toray Co., Ltd.) can be used.

Commercially available fluorine-based leveling agents can be used as the fluorine-based leveling agent. For example, commercially available products under the trade names “Optool DSX” and “Optool DAC-HP” (all above available from Daikin Industries, Ltd.); the trade names “SURFLON S-242”, “SURFLON S-243”, “SURFLON S-420”, “SURFLON S-611”, “SURFLON S-651”, and “SURFLON S-386” (all above available from AGC Seimi Chemical Co., Ltd.); the trade name “BYK-340” (available from BYK Japan KK); the trade names “AC 110a” and “AC 100a” (all above available from Algin Chemie); the trade names “MEGAFAC F-114”, “MEGAFAC F-410”, “MEGAFAC F-444”, “MEGAFAC EXP TP-2066”, “MEGAFAC F-430”, “MEGAFAC F-472SF”, “MEGAFAC F-477”, “MEGAFAC F-552”, “MEGAFAC F-553”, “MEGAFAC F-554”, “MEGAFAC F-555”, “MEGAFAC R-94”, “MEGAFAC RS-72-K”, “MEGAFAC RS-75”, “MEGAFAC F-556”, “MEGAFAC EXP TF-1367”, “MEGAFAC EXP TF-1437”, “MEGAFAC F-558”, and “MEGAFAC EXP TF-1537” (all above available from DIC Corporation); the trade names “FC-4430” and “FC-4432” (all above available from Sumitomo 3M Ltd.); the trade names “FTERGENT 100”, “FTERGENT 100C”, “FTERGENT 110”, “FTERGENT 150”, “FTERGENT 150CH”, “FTERGENT A-K”, “FTERGENT 501”, “FTERGENT 250”, “FTERGENT 251”, “FTERGENT 222F”, “FTERGENT 208G”, “FTERGENT 300”, “FTERGENT 310”, and “FTERGENT 400SW” (all above available from Neos Corporation); and the trade names “PF-136A”, “PF-156A”, “PF-151N”, “PF-636”, “PF-6320”, “PF-656”, “PF-6520”, “PF-651”, “PF-652”, and “PF-3320” (all above available from Kitamura Chemicals Co., Ltd.) can be used.

One type of these leveling agents can be used alone, or two or more types of these leveling agents can be used in combination. Among these leveling agents, silicone leveling agents having a hydroxyl group are preferable from the perspectives of having excellent affinity with the cationic curable silicone resin, being able to react with the epoxy groups, and being able to improve the hardness and appearance of the cured product.

Examples of the silicone-based leveling agent including a hydroxyl group include polyether modified polyorganosiloxanes obtained by introducing a polyether group into the main chain or the side chain of a polyorganosiloxane backbone (such as polydimethylsiloxane); polyester modified polyorganosiloxanes obtained by introducing a polyester group into the main chain or the side chain of the polyorganosiloxane backbone; and silicone-modified (meth)acrylic-based resins obtained by introducing a polyorganosiloxane into a (meth)acrylic-based resin. In these leveling agents, the hydroxyl group may have a polyorganosiloxane backbone and may have a polyether group, a polyester group, or a (meth)acryloyl group. Leveling agent products commercially available under trade names such as “BYK-370”, “BYK-SILCLEAN 3700”, and “BYK-SILCLEAN 3720”, can be used.

When the abovementioned leveling agent is used, the ratio of the leveling agent is not particularly limited and is, for example, from 0.01 to 10 parts by weight, preferably from 0.05 to 8 parts by weight, more preferably from 0.01 to 6 parts by weight, and even more preferably from 0.2 to 4 parts by weight, per 100 parts by weight of the cationic curable silicone resin. An excessively low ratio of the leveling agent poses a risk of decreasing the surface smoothness of the cured product, and an excessively high ratio poses a risk of decreasing the surface hardness of the cured product.

In particular, when a silicone-based leveling agent is used, the ratio of the leveling agent is not particularly limited and is, for example, from 0.01 to 10 parts by weight, preferably from 0.05 to 5 parts by weight, more preferably from 0.01 to 3 parts by weight, even more preferably from 0.2 to 2 parts by weight, and particularly preferably from 0.3 to 1.5 parts by weight, per 100 parts by weight of the cationic curable silicone resin. Furthermore, when a silicone-based leveling agent having a hydroxyl group is used, the ratio of the leveling agent is not particularly limited and is, for example, from 0.01 to 5 parts by weight, preferably from 0.05 to 4 parts by weight, more preferably from 0.1 to 3 parts by weight, even more preferably from 0.2 to 2 parts by weight, and particularly preferably from 0.3 to 1.5 parts by weight, per 100 parts by weight of the cationic curable silicone resin.

In particular, when a fluorine-based leveling agent is used, the ratio of the leveling agent is not particularly limited and is, for example, from 0.05 to 5 parts by weight, preferably from 0.1 to 3 parts by weight, more preferably from 0.15 to 2 parts by weight, even more preferably from 0.2 to 1 part by weight, and particularly preferably from 0.3 to 0.8 parts by weight, per 100 parts by weight of the cationic curable silicone resin. When the ratio of the leveling agent is adjusted to these ranges, not only the surface smoothness of the cured product can be improved, but also the surface hardness of a cured product tends to improve, which was not conventionally assumed to be a function of the leveling agent.

### Curing Catalyst

The curable composition preferably further contains a curing catalyst. From the perspective of being able to shorten the curing time until the curable composition becomes tack free, the curable composition particularly preferably contains a photocationic polymerization initiator as a curing catalyst.

The curing catalyst is a compound that can initiate or accelerate a cationic polymerization reaction of a cationic curable compound such as a cationic curable silicone resin. The curing catalyst is not particularly limited, and examples thereof include polymerization initiators such as photocationic polymerization initiators (photoacid generating agents) and thermal cationic polymerization initiators (thermal acid generating agents).

Well-known and commonly used photocationic polymerization initiators can be used as the photocationic polymerization initiator, and examples thereof include a sulfonium salt (a salt of a sulfonium ion and an anion), an iodonium salt (a salt of an iodonium ion and an anion), a selenium salt (a salt of a selenium ion and an anion), an ammonium salt (a salt of an ammonium ion and an anion), a phosphonium salt (a salt of a phosphonium ion and an anion), and a salt of a transition metal complex ion and an anion.

Examples of the sulfonium salt include a triarylsulfonium salt, such as a triphenylsulfonium salt, a tri-p-tolylsulfonium salt, a tri-o-tolylsulfonium salt, a tris(4-methoxyphenyl)sulfonium salt, a 1-naphthyldiphenylsulfonium salt, a 2-naphthyldiphenylsulfonium salt, a tris(4-fluorophenyl)sulfonium salt, a tri-1-naphthylsulfonium salt, a tri-2-naphthylsulfonium salt, a tris(4-hydroxyphenyl)sulfonium salt, a diphenyl[4-(phenylthio)phenyl]sulfonium salt, a 4-(p-tolylthio)phenyldi-(p-phenyl)sulfonium salt; a diarylsulfonium salt, such as a diphenylphenacylsulfonium salt, a diphenyl 4-nitrophenacylsulfonium salt, a diphenylbenzylsulfonium salt, and a diphenylmethylsulfonium salt; monoarylsulfonium salt, such as a phenylmethylbenzylsulfonium salt, a 4-hydroxyphenylmethylbenzylsulfonium salt, and a 4-methoxyphenylmethylbenzylsulfonium salt; and a trialkylsulfonium salt, such as a dimethylphenacylsulfonium salt, a phenacyltetrahydrothiophenium salt, and a dimethylbenzylsulfonium salt.

As the diphenyl [4-(phenylthio)phenyl]sulfonium salt, for example, a commercially available product such as diphenyl[4-(phenylthio)phenyl]sulfonium hexafluoroantimonate, diphenyl[4-(phenylthio)phenyl]sulfonium hexafluorophosphate can be used.

Examples of the iodonium salt include a product of the trade name “UV9380C” (a bis(4-dodecylphenyl)iodonium-hexafluoroantimonate 45% alkyl glycidyl ether solution, available from Momentive Performance Materials Japan LLC), a product of the trade name “RHODORSIL PHOTOINITIATOR 2074” (tetrakis(pentafluorophenyl)borate [(1-methylethyl)phenyl](methylphenyl)iodonium, available from Rhodia Japan Ltd.), a product of the trade name “WPI-124” (available from Wako Pure Chemical Industries, Ltd.), a diphenyliodonium salt, a di-p-tolyliodonium salt, a bis(4-dodecylphenyl)iodonium salt, and a bis(4-methoxyphenyl)iodonium salt.

Examples of the selenium salt include triarylselenium salts, such as a triphenylselenium salt, a tri-p-tolylselenium salt, a tri-o-tolylselenium salt, a tris(4-methoxyphenyl)selenium salt, and a 1-naphthyldiphenylselenium salt; diarylselenium salts, such as a diphenylphenacylselenium salt, a diphenylbenzylselenium salt, and a diphenylmethylselenium salt; monoarylselenium salts, such as a phenylmethylbenzylselenium salt; and trialkylselenium salts, such as a dimethylphenacylselenium salt.

Examples of the ammonium salt include tetraalkyl ammonium salts, such as a tetramethylammonium salt, an ethyltrimethylammonium salt, a diethyldimethylammonium salt, a triethylmethylammonium salt, a tetraethylammonium salt, a trimethyl-n-propylammonium salt, and a trimethyl-n-butylammonium salt; pyrrolidium salts, such as an N,N-dimethylpyrrolidium salt and an N-ethyl-N-methylpyrrolidium salt; imidazolinium salts, such as an N,N′-dimethylimidazolinium salt and an N,N′-diethylimidazolinium salt; tetrahydropyrimidium salts, such as an N,N′-dimethyltetrahydropyrimidium salt and an N,N′-diethyltetrahydropyrimidium salt; morpholinium salts, such as an N,N-dimethylmorpholinium salt and an N,N-diethylmorpholinium salt; piperidinium salts, such as an N,N-dimethylpiperidinium salt and an N,N-diethylpiperidinium salt; pyridinium salts, such as an N-methylpyridinium salt and an N-ethylpyridinium salt; imidazolium salts, such as an N,N′-dimethylimidazolium salt; quinolium salts, such as an N-methylquinolium salt; isoquinolium salts, such as an N-methylisoquinolium salt; thiazonium salts, such as a benzylbenzothiazonium salt; and acrydium salts, such as a benzylacrydium salt.

Examples of the phosphonium salt include tetraarylphosphonium salts, such as a tetraphenylphosphonium salt, a tetra-p-tolylphosphonium salt, and a tetrakis(2-methoxyphenyl)phosphonium salt; triarylphosphonium salts, such as a triphenylbenzylphosphonium salt; and tetraalkylphosphonium salts, such as a triethylbenzylphosphonium salt, a tributylbenzylphosphonium salt, a tetraethylphosphonium salt, a tetrabutylphosphonium salt, and a triethylphenacylphosphonium salt.

Examples of the salt of the transition metal complex ion include salts of chromium complex cations, such as (η⁵-cyclopentadienyl)(η⁶-toluene)Cr⁺ and (η⁵-cyclopentadienyl)(η⁶-xylene)Cr⁺; and salts of iron complex cations, such as (η⁵-cyclopentadienyl)(η⁶-toluene)Fe⁺ and (η⁵-cyclopentadienyl)(η⁶-xylene)Fe⁺.

Examples of the anion constituting the salts described above include SbF₆⁻, PF₆⁻, BF₄⁻, (CF₃CF₂)₃PF₃⁻, (CF₃CF₂CF₂)₃PF₃⁻, (C₆F₅)₄B⁻, (C₆F₅)₄Ga⁻, a sulfonate anion (such as a trifluoromethanesulfonate anion, a pentafluoroethanesulfonate anion, a nonafluorobutanesulfonate anion, a methanesulfonate anion, a benzenesulfonate anion, and a p-toluenesulfonate anion), (CF₃SO₂)₃C⁻, (CF₃SO₂)₂N⁻, a perhalogenate ion, a halogenated sulfonate ion, a sulfate ion, a carbonate ion, an aluminate ion, a hexafluorobismuthate ion, a carboxylate ion, an arylborate ion, a thiocyanate ion, and a nitrate ion.

Examples of the thermal cationic polymerization initiator include arylsulfonium salts, aryliodonium salts, allene-ion complexes, quaternary ammonium salts, aluminum chelates, and boron trifluoride amine complexes.

Examples of the arylsulfonium salt include hexafluoroantimonate salts. In the curable composition described above, commercially available products such as, for example, products of the trade names “SP-66” and “SP-77” (available from ADEKA Corporation); and products of the trade names “SAN-AID SI-60L”, “SAN-AID SI-80 L”, “SAN-AID SI-100L”, and “SAN-AID SI-150 L” (available from Sanshin Chemical Industry Co., Ltd.) can be used. Examples of the aluminum chelate include ethylacetoacetate aluminum diisopropylate and aluminum tris(ethylacetoacetate). Examples of the boron trifluoride amine complex include a boron trifluoride monoethyl amine complex, a boron trifluoride imidazole complex, and a boron trifluoride piperidine complex.

Note that, in the curable resin composition of an embodiment of the present invention, one type of catalyst can be used alone, or two or more types of catalysts can be used in combination.

When the curable composition of the present invention contains the curing catalyst described above, the content amount (compounded amount) thereof is, for example, from 0.01 to 3.0 parts by weight, preferably from 0.05 to 3.0 parts by weight, and more preferably from 0.1 to 1.0 parts by weight, per 100 parts by weight of the cationic curable silicone resin. When the content amount of the curing catalyst is set to 0.01 parts by weight or greater, the curing reaction can efficiently and sufficiently proceed, and there is a tendency for the surface hardness of the cured product to further improve. On the other hand, when the content amount of the curing catalyst is set to 3.0 parts by weight or less, the storage properties of the curable composition tend to further improve, and coloring of the cured product tends to be suppressed.

The curable composition may further include a cationic curable compound (other cationic curable compound) besides the abovementioned epoxy compound and cationic curable silicone resin. Known and commonly used cationic curable compounds can be used as the other cationic curable compound, and examples thereof include vinyl ether compounds.

### Other Additives

The curable composition may further include, as other optional components, commonly used additives, such as an inorganic filler, such as precipitated silica, wet silica, fumed silica, calcined silica, titanium oxide, alumina, glass, quartz, aluminosilicic acid, iron oxide, zinc oxide, calcium carbonate, carbon black, silicon carbide, silicon nitride, and boron nitride; an inorganic filler obtained by treating the above filler with an organosilicon compound, such as an organohalosilane, organoalkoxysilane, and organosilazane; an organic resin micropowder such as silicone resin, epoxy resin, and fluororesin; a filler, such as a conductive metal powder of silver, copper, or the like; a curing auxiliary agent; a solvent (such as an organic solvent); a stabilizer (such as an antioxidant, an ultraviolet absorber, a light-resistant stabilizer, a heat stabilizer, and a heavy metal inactivator); a flame retardant (such as a phosphorus-based flame retardant, a halogen-based flame retardant, and an inorganic flame retardant); a flame retardant auxiliary agent; a reinforcing material (such as an additional filler); a nucleating agent; a coupling agent (such as a silane coupling agent); a lubricant; a wax; a plasticizer; a releasing agent; an impact resistance improving agent; a hue modifier; a transparentizing agent; a rheology modifier (such as a fluidity modifier); a processability modifier; a colorant (such as a dye and a pigment); an antistatic agent; a dispersant; a surface modifier (such as a slipping agent); a matting agent; an antifoaming agent; a foaming suppressor; a defoaming agent; an antibacterial agent; a preservative; a viscosity modifier; a thickening agent; a photosensitizer; and a foaming agent. One type alone or two or more types of these additives in combination can be used.

### Method for Producing the Curable Composition

The method for producing the curable composition is not particularly limited, and the curable composition can be prepared by agitating and mixing each component described above at room temperature or under heating as necessary. Here, the curable composition can be used as a one-part liquid composition in which each component is mixed beforehand and the mixture is used as is or, alternatively, can be used as a multi-part (for example, two-part) liquid composition in which two or more separately stored components are mixed at a predetermined ratio before use and then used.

The curable composition is not particularly limited but is preferably a liquid at normal temperature (about 25° C.). More specifically, the viscosity of a liquid of the curable composition diluted with a solvent to 20% (in particular, a curable composition (solution) with a ratio of methyl isobutyl ketone of 20 wt. %) at 25° C. is preferably from 300 to 20000 mPa·s, more preferably from 500 to 10000 mPa·s, and even more preferably from 1000 to 8000 mPa·s. The curable composition with the viscosity of 300 mPa·s or greater tends to further improve the heat resistance of the cured product. On the other hand, the curable composition with the viscosity of 20000 mPa·s or less facilitates the preparation and handling ease of the curable composition and tends to less likely to leave residual bubbles in the cured product. Here, the viscosity of the curable composition is measured using a viscometer (trade name “MCR301”, available from Anton Paar GmbH) under conditions including a swing angle of 5%, a frequency of from 0.1 to 100 (1/s), and a temperature of 25° C.

### Cured Product

By allowing a polymerization reaction of the curable compound having a curing expansion property in the curable composition to proceed, the curable composition can be cured, and a cured product can be obtained. The curing method can be appropriately selected from well-known methods, and examples thereof include a method of irradiation with active energy rays and/or heating. As the active energy rays, for example, any of the infrared rays, visible light rays, ultraviolet rays, X-rays, electron beams, α-rays, β-rays, and γ-rays can be used. Among these, ultraviolet rays are preferable in terms of excelling in handling ease.

The condition for curing the curable composition by irradiation with active energy rays (active energy ray irradiation condition, etc.) can be appropriately adjusted according to the type and energy of the active energy ray to be irradiated, the shape and size of the cured product, or the like, and in the case of irradiation with ultraviolet rays, the irradiation condition thereof is, for example, approximately from 1 to 10000 mJ/cm² and preferably from 50 to 10000 mJ/cm². In addition, for example, a high-pressure mercury lamp, an ultra high-pressure mercury lamp, a xenon lamp, a carbon arc, a metal halide lamp, sunlight, an LED lamp, and a laser, etc. can be used for irradiation with active energy rays. After irradiation with the active energy rays, the curing reaction can be further allowed to proceed by further subjecting to a heating treatment (annealing and aging).

On the other hand, the conditions when curing the curable composition by heating are, for example, from 30 to 200° C. and preferably from 50 to 190° C. The curing time can be appropriately set.

By curing the curable composition containing the cationic curable silicone resin in the manner described above, a cured product can be formed that exhibits high surface hardness and heat resistance, and excels in pliability, flexibility, and processability. Therefore, the curable composition containing the cationic curable silicone resin can be particularly preferably used as a “curable composition for forming a hard coat layer” (may be referred to as a “hard coat liquid” or a “hard coat agent”, etc.) for forming the hard coat layer in the hard coat film. The hard coat film having the hard coat layer formed from the said composition using the curable composition as a hard coat layer forming curable composition exhibits pliability and flexibility while maintaining high hardness and high heat resistance and can be produced and processed by using a roll-to-roll process.

### Base Material

The base material that is used in the base material layer of the present invention is not particularly limited, and a well-known or commonly used base material can be used, such as a plastic base material, a metal base material, a ceramic base material, a semiconductor base material, a glass base material, a paper base material, a wood base material (wooden base material), and a base material of which the surface is a coated surface. Among these, a plastic base material (base material constituted of a plastic material) is preferable.

The plastic material constituting the plastic base material is not particularly limited, and examples include various plastic materials such as polyesters, such as polyethylene terephthalate (PET) and polyethylene naphthalate (PEN); polyimides; polycarbonates; polyamides; polyacetals; polyphenylene oxides; polyphenylene sulfides; polyethersulfones; polyetheretherketones; cyclic polyolefins, such as homopolymers of norbornene-based monomers (such as addition polymers and ring-opening polymers), copolymers of a norbornene-based monomer and an olefin-based monomer (such as cyclic olefin copolymers, such as addition polymers and ring-opening polymers), such as a copolymer of norbornene and ethylene, and derivatives thereof; vinyl-based polymers (for example, acrylic resins, such as polymethyl methacrylates (PMMA), polystyrenes, polyvinyl chlorides, and acrylonitrile-styrene-butadiene resins (ABS resins)); vinylidene polymers (for example, such as polyvinylidene chlorides); cellulose resins, such as triacetyl cellulose (TAC); epoxy resins; phenolic resins; melamine resins; urea resins; maleimide resins; and silicones. Here, the above plastic substrate may be constituted of only one type of plastic material or may be constituted of two or more types of plastic materials.

Among the above plastic base materials, when the object is to obtain a hard coat film having excellent transparency as a hard coat film, a base material having excellent transparency (transparent base material) is preferably used, and more preferably a polyester film (in particular, PET and PEN), a cyclic polyolefin film, a polycarbonate film, a TAC film, or a PMMA film is used.

The plastic base material may contain other additives as necessary, such as an antioxidant, an ultraviolet absorber, a light-resistant stabilizer, a thermal stabilizer, a crystal nucleating agent, a flame retardant, a flame retardant auxiliary agent, a filler, a plasticizer, an impact resistance improving agent, a reinforcing agent, a dispersant, an antistatic agent, a foaming agent, and an antibacterial agent. Here, one type of additive can be used alone, or two or more types thereof can be used in combination.

The plastic base material may have a single layer configuration, or may have a multilayer (laminated) configuration, and the configuration (structure) thereof is not particularly limited. For example, the plastic base material may be a plastic base material having a laminated configuration such as a “plastic film/other layer” or “other layer/plastic film/other layer” in which a layer other than the hard coat layer (may be referred to simply as an “other layer”) is formed on at least one surface of the plastic film. Examples of the other layer include a hard coat layer other than the hard coat layer. Examples of material constituting the abovementioned other layer include the above-described plastic materials and the like.

A portion or the entirety of the surface of the plastic material described above may be subjected to a known and commonly used surface treatment such as roughening treatment, adhesion-facilitating treatment, antistatic treatment, sand blast treatment (sand mat treatment), corona discharge treatment, plasma treatment, chemical etching treatment, water mat treatment, flame treatment, acid treatment, alkali treatment, oxidation treatment, ultraviolet irradiation treatment, and silane coupling agent treatment. Here, the plastic substrate may be an unstretched film or a stretched film (such as a uniaxially stretched film and a biaxially stretched film).

The thickness of the base material is, for example, approximately from 1 to 1000 μm, preferably from 5 to 500 μm, and most preferably from 25 to 80 μm. If the thickness of the base material is thinner than 1 μm (for example 25 μm), defects such as the occurrence of larger reverse curling are likely to occur. On the other hand, if the thickness of the base material is thicker than 1000 μm (for example, 80 μm), handling ease tends to decline.

### Adhesive Layer

The adhesive layer of the present invention is not particularly limited as long as the adhesive layer has weak adhesiveness that allows release from the hard coat layer, and examples thereof include an adhesive layer formed from one or more known and commonly used weak adhesives such as acrylic adhesives, natural rubber adhesives, synthetic rubber-based adhesives, ethylene-vinyl acetate copolymer-based adhesives, ethylene-(meth) acrylate copolymer-based adhesives, styrene-isoprene block copolymer-based adhesives, and styrene-butadiene block copolymer-based adhesives. Various additives (for example, antistatic agents, slip agents, etc.) may be included in the adhesive layer. Note that the adhesive layer may each have a single layer configuration or may have a multilayer (multiple layer) configuration.

The thickness of the adhesive layer can be appropriately selected from a range from 1 to 100 μm, for example, and is preferably from 5 to 75 μm, and most preferably from 10 to 50 μm. In a case where the thickness of the adhesive layer is less than 1 μm, the adhesive force decreases, a below-described residual stress in the surface protection film cannot be withstood, and problems such as peeling from the hard coat layer easily occur. On the other hand, when the thickness of the adhesive layer is greater than 100 μm, the below-described residual stress in the surface protection film is absorbed, and problems such as a reduction in the reverse curling suppression effect easily occur.

### Surface Protection Film

The surface protection film of the hard coat film of the present invention has an internal residual stress that is compressible with respect to the hard coat layer. By providing the surface protection film with an internal residual stress that is compressible with respect to the hard coat layer, the internal residual stress thereof balances the reverse curling caused by the cured expansion of the hard coat layer, thus reverse curling of the entire hard coat film (base material layer/hard coat layer/adhesive layer/surface protection film) can be suppressed, and a processing treatment such as affixing a circular polarizing plate or edge printing can be implemented. Moreover, punching processability tends to be further improved by providing a surface protection film. For example, even if the hardness of the hard coat layer is extremely high and the hard coat layer is such that peeling from the base material and cracking readily occur during the punching process, punching using a Thomson blade can be performed without causing such problems.

FIG. 1 is a cross-sectional schematic view of an example of a preferable aspect of the hard coat film of the present invention. Reference sign 1 denotes a hard coat film of the present invention, 2 denotes a surface protection film, 3 denotes an adhesive layer, 4 denotes a hard coat layer, and 5 denotes a base material layer. An arrow 6 indicates the residual stress present within the surface protection film, and the direction of the arrow indicates that residual stress that is compressible with respect to the hard coat layer 4 is present.

In FIG. 1, the direction of the internal residual stress 6 in the plane of the surface protection film 2 is not particularly limited as long as the internal residual stress 6 is present in at least one direction. Furthermore, the internal residual stress 6 may be present in a plurality of directions, and for example, when the hard coat film of the present invention is in a roll shape, the internal residual stress 6 may be present in at least one of the TD direction (width direction) or the MD direction (machine flow direction) or may be present in both directions. From the perspective of production ease, an aspect in which the internal residual stress 6 is present in at least the MD direction is preferable.

The method for imparting the internal residual stress to the surface protection film of the hard coat film of the present invention is not particularly limited, and for example, the internal residual stress 6 can be imparted by a below-described method for producing a hard coat film of the present invention The details are described below.

The strength of the internal residual stress in the surface protection film of the hard coat film of the present invention is not particularly limited and is set as appropriate depending on the thickness of each layer (base material layer/hard coat layer/adhesive layer/surface protection film) of the hard coat film of the present invention and on the strength of the reverse curling due to curing expansion of the hard coat layer. That is, the internal residual stress can be set to a large value when the reverse curling amount is large and can be set to a small value when the reverse curling amount is small.

In the above surface protection film, the strength of the internal residual stress can be set in the below-described hard coat film production method of the present invention by, for example, adjusting a below-described difference between a tension imparted to a first film and a tension imparted to a second film (tension imparted to the second film—tension imparted to the first film).

A known and commonly used surface protection film can be used as the surface protection film, and, for example, a film having an adhesive layer on the surface of a plastic film can be used. Examples of the plastic film include plastic films formed using a plastic material such as a polyester resin (polyethylene terephthalate, polyethylene naphthalate, etc.), a polyolefin resin (polyethylene, polypropylene, cyclic polyolefin, etc.), a polystyrene resin, an acrylic resin, a polycarbonate, an epoxy resin, a fluororesin, a silicone resin, a diacetate resin, a triacetate resin, a polyarylate resin, a polyvinyl chloride resin, a polysulfone resin, a polyethersulfone resin, a polyether ether imide resin, a polyimide resin, and a polyamide resin. From the perspective of applying sufficient tension to the below-described second film in the hard coat film production method of the present invention described below, a polyester resin is preferable, and polyethylene terephthalate is particularly preferable. Note that each plastic film may have a single layer configuration or may have a multilayer (multiple layer) configuration.

The thickness of the surface protection film can be appropriately selected from a range from 25 to 250 μm, for example, and is preferably from 26 to 188 m and most preferably from 38 to 75 μm. In a case where the thickness of the surface protection film is thinner than 25 μm, problems such as a reduction in the reverse curling suppression effect may occur. On the other hand, when the thickness of the surface protection film is greater than 250 μm, handling ease may decrease.

### Hard Coat Film Production Method

The hard coat film production method of the present invention is not particularly limited, and for example, the hard coat film can be produced by setting the tension imparted to a below-described second film to a value that is larger than the tension imparted to a below-described first film when bonding a hard coat layer of the first film to an adhesive layer of the second film, through the following steps.

Conveying the first film and the second film in a state of being tensioned along the respective machine flow directions (MD), such that the hard coat layer of the first film and the adhesive layer of the second film are mutually facing.

Bonding the hard coat layer of the first film to the adhesive layer of the second film.

Note that the hard coat film method production method of the present invention may include steps other than those described above (for example, providing an anchor layer, winding, etc.).

### First Film

The first film used in the hard coat film production method of the present invention has a base material and a hard coat layer formed on one surface of the base material, the hard coat layer is formed of a cured product of a curable composition, and the curable composition contains a curable compound having a curing expansion property.

The configurations of the “base material”, “hard coat layer”, “curable composition”, and “curable compound having a curing expansion property” of the first film of the present invention are the same as the “base material”, “hard coat layer”, “curable composition”, and “curable compound having a curing expansion property” of the above-described hard coat film of the present invention.

The bending (bendability) of the first film of the present invention is, for example, 30 mm or less (for example, from 1 to 30 mm), preferably 25 mm or less, more preferably 20 mm or less, and even more preferably 15 mm or less. Note that bending (bendability) can be evaluated in accordance with JIS K5600-5-1 using a cylindrical mandrel.

The haze of the first film of the present invention is, for example, 1.5% or less and preferably 1.0% or less. In addition, the lower limit of the haze is, for example, 0.1%. When the haze is set particularly to 1.0% or less, the first film tends to be suitable for use, for example, in applications requiring very high transparency (for example, a surface protection sheet of a display of a touch panel or the like). The haze of the first film according to an embodiment of the present invention can be easily controlled to the above range by, for example, using a below-described transparent base material as the base material. Here, the haze can be measured according to JIS K7136.

The total light transmittance of the first film according to an embodiment of the present invention is, for example, 85% or greater and preferably 90% or greater. In addition, the upper limit of the total light transmittance is, for example, 99%. When the total light transmittance is set to particularly 90% or greater, the first film tends to be suitable for use, for example, in applications requiring very high transparency (for example, a surface protection sheet of a display of a touch panel, etc.). The total light transmittance of the first film according to an embodiment of the present invention can be easily controlled to the above range by, for example, using the transparent base material described below as the base material. Here, the total light transmittance can be measured according to JIS K7361-1.

The first film of the present invention is not particularly limited and can be prepared by forming a hard coat layer on one surface of the base material. The hard coat layer can be produced according to a known and commonly used method for producing a hard coat film, and the production method thereof is not particularly limited. For example, the hard coat layer can be produced by applying the curable composition (curable composition for forming a hard coat layer) onto one surface of the base material, removing the solvent through drying as necessary, and then curing the curable composition (curable composition layer). The conditions when curing the curable composition can be appropriately selected from the above-described conditions for forming the cured product. Note that the first film may be a hard coat sheet with a base material.

In particular, when the hard coat layer of the first film of the present invention is formed from a curable composition containing the cationic curable silicone resin, the hard coat layer is formed from the curable composition (hard coat layer forming curable composition) capable of forming a cured product excelling in pliability, flexibility, and processability and therefore can be produced with a roll-to-roll process. Producing the hard coat layer with a roll-to-roll process can significantly increase the productivity thereof. A known and commonly used roll-to-roll process based production method can be adopted, and for example, the production method can be a method that includes, as essential steps, feeding out a base material wound in a roll shape; forming a hard coat layer by applying a curable composition (hard coat layer forming curable composition) to at least one surface of the base material that has been fed out, next removing the solvent by drying as necessary, and then curing the curable composition (curable composition layer); and subsequently winding the obtained hard coat film with a base material onto a roll once again; and these steps can be continuously implemented. In addition, the method may include steps besides these steps. Furthermore, the obtained first film of the present invention excels in pliability, flexibility, and processability, therefore, the conveying and the bonding of the present invention described below can also be performed with a roll-to-roll process, and the hard coat film of the present invention can be efficiently produced.

The thickness of the first film according to an embodiment of the present invention is, for example, from 10 to 1000 μm, preferably from 15 to 800 μm, more preferably from 20 to 700 rtm, and even more preferably from 30 to 500 μm.

### Second Film

The second film used in the hard coat film production method of the present invention has a surface protection film and an adhesive layer formed on one surface of the surface protection film. The configurations of the “surface protection film” and the “adhesive layer” of the second film of the present invention are the same as the “surface protection film” and “adhesive layer” of the hard coat film of the present invention described above.

The second film of the present invention is not particularly limited and can be prepared by forming a hard coat layer on one surface of the surface protection film. The adhesive layer can be produced in accordance with a known and commonly used method for producing an adhesive film, and the production method thereof is not particularly limited. For example, the adhesive layer can be produced by applying the above-described adhesive to one surface of the surface protection film, then removing the solvent through drying, and then as necessary, heating or irradiating with light. The heating or irradiation with light is performed under the same conditions as those for forming the hard coat layer of the first film.

A commercially available surface protection film with an adhesive layer can be used as the second film without particular limitation, and for example, commercially available products such as products of the “Sunytect” series (available from Sun A. Kakan Co., Ltd.), products of the “E-MASK” series (available from Nitto Denko Corporation), products of the “Mastack” series (available from Fujimori Kogyo Co., Ltd.), products of the “Hitalex” series (available from Hitachi Chemical Co., Ltd.), and products of the “Alphan” series (available from Oji F-Tex Co., Ltd.) can be procured from the market.

The method for producing the hard coat film of the present invention can use, without particular limitation, techniques that are well known in the field of films, and for example, a roll-to-roll process and an in-line process can be set as specifications, but a roll-to-roll process that excels in efficiency and production costs is preferable. In particular, a hard coat layer obtained by curing the curable composition containing the cationic curable silicone resin excels in pliability and flexibility even when the surface hardness is high and therefore provides an advantage of being able to produce the hard coat film of high surface hardness with the roll-to-roll process.

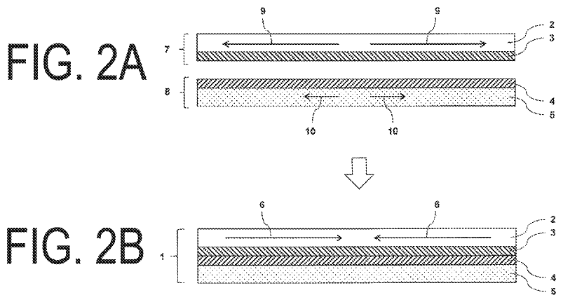

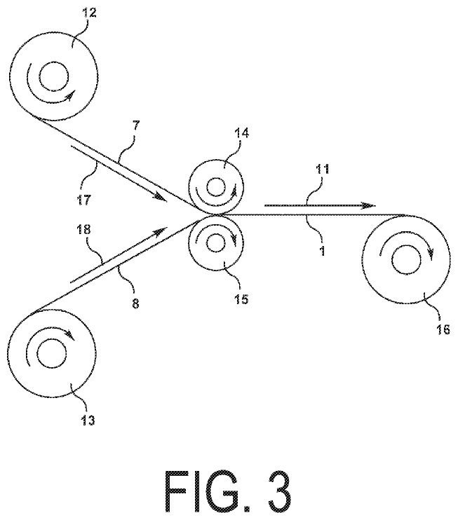

FIG. 2 is a cross-sectional schematic view illustrating an example of a preferable aspect in which the hard coat film of the present invention is produced with an in-line process, and FIG. 3 is a cross-sectional schematic view illustrating an example of a preferable aspect in which the hard coat film of the present invention is produced with a roll-to-roll process.

### Conveying and Bonding

In FIG. 2, 7 denotes a second film, 8 denotes a first film, 2 denotes a surface protection film, 3 denotes an adhesive layer, 4 denotes a hard coat layer, 5 denotes a base material layer, arrows 6 denote residual stress present in the surface protection film, and the direction of the arrows indicates that residual stress that is compressive with respect to the hard coat layer 4 is present in the interior of the surface protection film 2. Arrows 9 indicate the tension imparted to the second film in the conveying, arrows 10 indicate the tension imparted to the first film in the conveying, the lengths of the arrows 9 and 10 indicate the strength of the imparted tensions, and a longer length indicates that a stronger tension is applied.

In FIG. 3, 7 denotes is a second film (configuration is not illustrated), 12 denotes a feeding roll for the second film 7, 17 denotes the direction (MD direction) in which the second film 7 is conveyed, 14 denotes a bonding roller that contacts the surface protection film side (configuration is not illustrated) of the second film 7, 8 denotes a first film (configuration is not illustrated), 13 denotes a feeding roll for the first film 8, 18 denotes the direction (MD direction) in which the first film 8 is conveyed, 15 denotes a bonding roller that contacts the base material side (configuration is not illustrated) of the first film 8, 1 denotes a hard coat film (configuration is not illustrated) of the present invention, 11 denotes the direction (MD direction) in which the hard coat film 1 is conveyed, and 16 is a winding roll for the hard coat film 1.

FIG. 2A illustrates how the first film 8 and the second film 7 are conveyed in respectively tensioned states such that the hard coat layer 4 of the first film 8 and the adhesive layer 3 of the second film 7 face each other. In FIG. 2A, the tension 9 imparted to the second film 7 is set to a larger value than the tension 10 imparted to the first film 8.

FIG. 2B illustrates the hard coat film 1 of the present invention. The downward arrow from FIG. 2A to FIG. 2B indicates that the hard coat layer 4 of the first film 8 and the adhesive layer 3 of the second film 7 are bonded together to obtain the hard coat film 1 of the present invention.

The compressive stress 6 can be caused to remain within the surface protection film 2 by bonding the films together in a state in which the tension 9 is greater than the tension 10.

The magnitude (T₂) of the tension 9 is not particularly limited and is set, as appropriate, depending on the thicknesses of the adhesive layer and surface protection film in the second film and on the strength of the reverse curling due to the curing expansion of the hard coat layer in the first film. That is, T₂ can be set to a larger value when the reverse curling amount is large and can be set to a smaller value when the reverse curling amount is small, and for example, as the tension per unit cross-sectional area (N/mm²=MPa) in the width direction of the second film, T₂ is preferably from 0.5 to 10 N/mm² and more preferably from 1 to 5 N/mm². If T₂ is less than 0.5 N/mm², the effect of suppressing reverse curling may not be sufficiently exhibited. On the other hand, if T₂ is greater than 10 N/mm², the elastic limit (yield point) of the second film may be exceeded, the contraction force due to elastic recovery and also the internal residual stress 6 will be weakened, and the effect of suppressing reverse curling may not be sufficiently exhibited.

The magnitude (T₁) of the tension 10 is not particularly limited and is set, as appropriate, depending on the thicknesses of the base material layer and the hard coat layer in the first film and on the strength of the reverse curling due to curing expansion of the hard coat layer in the first film. The first film may be substantially free of T₁, and even when the tension 10 is applied, a weak tension of an extent that the reverse curling of the first film becomes flat is sufficient. For example, as the tension per unit cross-sectional area (N/mm²) in the width direction of the first film, T₁ is preferably from 0 to 3 N/mm² and is more preferably from 0.5 to 2 N/mm². If T₁ is greater than 3 N/mm², cracks may be generated in the hard coat layer of the first film, and optical properties such as transparency may decline.

A ratio (T₂/T₁) of the tension 9 to the tension 10 is not particularly limited and is set, as appropriate, depending on the thicknesses of the adhesive layer and the surface protection film in the second film, on the thicknesses of the base material layer and the hard coat layer in the first film, and on the strength of the reverse curling due to the cured expansion of the hard coat layer in the first film. That is, T₂/T₁ can be set in a range greater than 1, is set to a larger value when the reverse curling amount is large, and is set to a smaller value when the reverse curling amount is small, and for example, T₂/T₁ is set preferably to greater than 1 and not more than 5 and more preferably from 1.1 to 2. If T₂/T₁ is smaller than 1, the effect of suppressing reverse curling may not be sufficiently exhibited. On the other hand, if T₂/T₁ is greater than 5, the internal residual stress 6 becomes too large, and problems such as peeling of the adhesive layer 3 from the hard coat layer 4 may occur.

The difference (T₂−T₁) between the tension 9 and the tension 10 is not particularly limited and is set, as appropriate, depending on the thicknesses of the adhesive layer and the surface protection film in the second film, on the thicknesses of the base material layer and the hard coat layer in the first film, and on the strength of the reverse curling due to the cured expansion of the hard coat layer in the first film. In other words, T₂−T₁ can be set in a range greater than 0 and is set to a large value when the reverse curling amount is large and is set to a small value when the reverse curling amount is small, and for example, T₂−T₁ is preferably from 0.1 to 5 N/mm² and more preferably from 0.25 to 2.5 N/mm². If T₂−T₁ is less than 0.1 N/mm², the effect of suppressing reverse curling may not be sufficiently exhibited. On the other hand, if T₂−T₁ is greater than 5 N/mm², the internal residual stress 6 becomes too large, and problems such as peeling of the adhesive layer 3 from the hard coat layer 4 may occur.

The strength (MPa) of the internal residual stress 6 in the hard coat film of the present invention that is produced can be set to a desired range by adjusting the difference (T₂−T₁) between the tension 9 and the tension 10. That is, the difference of T₂−T₁ (N/mm²) may be considered to be the strength (MPa) of the internal residual stress 6.

As the method for imparting the tension 9 and the tension 10 to the second film and first film respectively, known techniques for producing films can be applied without limitation, but from the perspectives of being able to implement production efficiently and at a low cost, a method of imparting the tension 9 and the tension 10 to the second film and the first film respectively by adjusting the circumferential speeds of each of the feeding rolls 12 and 13 and the winding roll 16 in FIG. 3 is preferable.

In FIG. 3, the second film 7 is wound in a roll shape on the feeding roll 12, and the long second film 7 is fed out. Meanwhile, the first film 8 is wound in a roll shape on the feeding roll 13, and the long first film 8 is fed out. In FIG. 3, the second film 7 is disposed so that the adhesive layer faces downward (not illustrated), and the first film 8 is disposed so that the hard coat layer faces upward (not illustrated). The second film 7 and the first film 8 are conveyed in the directions of the arrows 17 and 18, respectively, and are supplied to bonding rollers 14 and 15 so that the adhesive layer and the hard coat layer are mutually facing, and the second film 7 and the first film 8 are bonded in the below-described bonding.

The conveyance speeds of each of the first and second films are not limited and may be set to a value suitable for the production apparatus. However, normally, the conveyance speeds thereof are set to a speed that matches the conveyance speed of each film produced and conveyed in the previous step. In addition, as long as the hard coat film of the present invention is not restricted by the type or quality of product to be used, the conveyance speed is preferably faster from the perspective of productivity because as the conveyance speed increases, the takt time becomes faster. The conveyance speed can be set, for example, to approximately from 1 to 30 m/minutes.

The directions in which the first and second films are each conveyed are not particularly limited as long as the first and second films are stacked at the end of the conveying. As illustrated in FIG. 3, the first and second films may each be conveyed in mutually opposite oblique directions. While not illustrated, there may be portions where the first and second films are conveyed in a vertically oriented direction, and there may be portions where the first and second films are conveyed in parallel. Furthermore, in cases where there is a constraint on the arrangement of the production device, the first and second films may each be fed out in a direction that differs from the conveyance direction and then subjected to a change in direction by an appropriate roll and conveyed.

In FIG. 3, the tension 9 (T₂) (not illustrated) is imparted in the machine flow direction 17 (MD direction) to the second film 7 fed out from the feeding roll 12, and the tension 10 (T₂₁) (not illustrated) is imparted in the machine flow direction 18 (MD) direction to the first film 8 fed out from the feeding roll 13. In FIG. 3, the tension 9 can be imparted by applying a difference in the circumferential speeds of the rolls between the feeding roll 12 for feeding out the second film 7 wound in a roll shape and the winding roll 16 for winding the hard coat film 1 of the present invention after the bonding described below. Similarly, in FIG. 3, the tension 10 can be imparted by applying a difference in the circumferential speeds of the rolls between the feeding roll 13 for feeding out the first film 8 wound in a roll shape and the winding roll 16 for winding the hard coat film 1 of the present invention after the bonding described below. In other words, the tensions 9 and 10 can be imparted to the first and second films by setting the circumferential speed of the winding roll 16 to be greater than the circumferential speeds of the feeding roll 12, 13; and pulling the first and second films in the machine flow directions 17, 18 (MD directions), respectively.

Therefore, in FIG. 3, the tension 9 can be made larger than the tension 10 by making the difference between the circumferential speeds of the feeding roll 12 and the winding roll 16 to be greater than the difference between the circumferential speeds of the feeding roll 13 and the winding roll 16.

The first and second films conveyed in FIG. 3 are supplied to the subsequent bonding. In the bonding, a laminate of the second film 7/first film 8 is bonded while being sandwiched between the bonding roller 14 that contacts the surface protection film of the second film 7 and the bonding roller 15 that contacts the base material side of the first film 8. The bonding roller 14 and the bonding roller 15 rotate in the respective conveyance directions of the second film 7 contacted thereby and the first film 8 contacted thereby, and the curved arrows in FIG. 3 indicate the rotational directions thereof. As a result, the adhesive layer of the second film and the hard coat layer of the first film are bonded together, and the hard coat film 1 (not illustrated in FIG. 3) of the present invention is obtained as illustrated in FIG. 2B.

Examples of the material of the surface constituting the bonding rollers 14, 15 include metals such as stainless steel, copper alloy, and chrome plated products; rubbers such as polyurethane, polyfluoroethylene, and silicone; and ceramics obtained by thermal spraying one or more of chromium oxide, silicon oxide, zirconium oxide, and aluminum oxide.

In FIG. 3, the hard coat film 1 of the present invention obtained in the bonding can be wound on the winding roll 16 in a roll shape. In FIG. 3, the hard coat film 1 of the present invention is wound with the base material oriented to the inside, but the winding direction is not limited thereto, and the hard coat film 1 may be wound with the surface protection film side oriented to the inside.

Since reverse curling of the hard coat film of the present invention is effectively suppressed, processing treatments such as, for example, edge printing or affixing a circular polarizing plate can be suitably performed. In particular, when the hard coat layer is formed from a curable composition containing the cationic curable silicone resin, the hard coat layer exhibits pliability and flexibility while maintaining a high level of hardness and high heat resistance and can be produced and processed with a roll-to-roll process, and therefore the hard coat film of the present invention has high quality and excels in productivity. Thus, the hard coat film of the present invention can be preferably used in various products including, for example, display devices, such as liquid crystal displays and organic EL displays; input devices, such as touch panels; solar cells; various household electric appliances; various electrical and electronic products; various electrical and electronic products of portable electronic terminals (for example, gaming devices, personal computers, tablets, smartphones, mobile phones, etc.); and various optical devices. Examples of aspects in which the hard coat film of the present invention is used as various products or as a constituent material of members or components thereof include aspects used in, for example, a laminate of a hard coat film and a transparent conductive film in a touch panel.

The hard coat film of the present invention can be used after a treatment such as edge printing or affixing a circular polarizing plate or used at the time of use after product shipment when the second film is peeled from the hard coat layer and the hard coat layer is disposed on the outermost surface.

### EXAMPLES

Hereinafter, the present invention will be described in more detail based on examples, but the present invention is not limited by these examples. The molecular weight of a product was measured using an Alliance HPLC system 2695 (available from Waters), a Refractive Index Detector 2414 (available from Waters), a column: Tskgel GMH_{HR}-M×quantity of 2 (available from Tosoh Corporation), a guard column: Tskgel guard column HH_{R}L (available from Tosoh Corporation), a column oven: COLUMN HEATER U-620 (available from Sugai), and a solvent of THF, at a measurement condition of 40° C. In addition, the ratio of the T2 form and the T3 form [T3 form/T2 form] in the product was measured through ²⁹Si-NMR spectrum measurements using a JEOL ECA500 (at 500 MHz). The T_{d5} (5% weight loss temperature) of the product was measured through thermogravimetric analysis (TGA) at a temperature increase rate of 5° C./min in an air atmosphere.

### Synthesis Example 1: Synthesis of Curable Resin A (Cationic Curable Silicone Resin)

To a 300 mL flask (reaction vessel) equipped with a thermometer, a stirrer, a reflux condenser, and a nitrogen inlet tube, under a nitrogen stream, 161.5 mmol (39.79 g) of 2-(3,4-epoxycyclohexyl)ethyltrimethoxysilane (hereinafter, referred to as “EMS”), 9 mmol (1.69 g) of phenyltrimethoxysilane (hereinafter, referred to as “PMS”), and 165.9 g of acetone were charged, and the temperature was raised to 50° C. To the mixture thus obtained, 4.70 g of a 5% potassium carbonate aqueous solution (1.7 mmol as potassium carbonate) was added dropwise over 5 minutes, and then 1700 mmol (30.60 g) of water was added dropwise over 20 minutes. Here, no significant temperature increase occurred during the dropwise additions. Subsequently, a polycondensation reaction was performed under a nitrogen stream for 4 hours while maintaining the temperature at 50° C.

A product in the reaction solution after the polycondensation reaction was analyzed to reveal a number average molecular weight of 1911 and a molecular weight dispersity of 1.47. A ratio of the T2 form and the T3 form [T3 form/T2 form] calculated from the ²⁹Si-NMR spectrum of the product was 10.3.

Subsequently, the reaction solution was cooled and washed with water until the lower layer liquid became neutral. The upper layer liquid was collected, and then the solvent was distilled off from the upper layer liquid under conditions of 1 mmHg and 40° C. to obtain a colorless transparent liquid product (cationic curable silicone resin). The T_{d5} of the product was 370° C.

When the FT-IR spectrum of the curable resin A (cationic curable silicone resin) obtained in Synthesis Example 1 was measured by the method described above, it was confirmed that each case had one inherent absorption peak around 1100 cm¹.

### Production Example 1

### Preparation of Hard Coat Film (First Film)

A mixed solution containing 61.6 parts by weight of the curable resin A (cationic curable silicone resin) obtained in Synthesis Example 1, 6.9 parts by weight of a compound having an alicyclic epoxy group (trade name “EHPE3150” available from Daicel Corporation), 30 parts by weight of methyl isobutyl ketone (MIBK) (available from Kanto Chemical Co., Inc.), 1 part by weight of a photocationic polymerization initiator (trade name “CPI-210S”, available from San-Apro Ltd.), 0.3 parts by weight of silicon acrylate (trade name “KRM8479”, available from Daicel-Allnex Ltd.), and 0.2 parts by weight of silica particles having a group containing a (meth)acryloyl group on surface (trade name “BYK-LPX 22699”, available from BYK Japan KK) was prepared and used as a curable composition.

The curable composition obtained above was cast-coated on polyethylene naphthalate (PEN) film (trade name “TEONEX” (registered trademark), available from Teijin DuPont Films Co., Ltd., thickness of 50 μm) using a wire bar #44 such that the thickness of the hard coat layer after curing was 40 μm, after which the coated film was left in an oven at 80° C. for 1 minute (pre-baked) and then irradiated with ultraviolet rays for 5 seconds (ultraviolet irradiation dose: 400 mJ/cm²). Finally, the coated film was heat-treated (aged) at 150° C. for 30 minutes to prepare a hard coat film having a hard coat layer (hard coat layer/base material).

The hard coat film (hard coat layer/base material) obtained as described above was then subjected to various evaluations using the following methods, and evaluation results of stain repellency: good, appearance: excellent, pencil hardness: 9H, and scratch resistance: 400 times OK, 500 times NG were obtained.

### Stain Repellency: Water Contact Angle

The water contact angle of the surface of the hard coat film (the surface of the hard coat layer) was measured (by sessile drop method) to evaluate stain repellency according to the following criteria.

Good (Stain repellency was good): Water contact angle was 90° or greater

Poor (Stain repellency was poor): Water contact angle was less than 900

### Appearance

The surface of the hard coat film (the surface of the hard coat layer) was visually observed under fluorescent light to evaluate the appearance.

Excellent (Appearance was excellent): The surface had no distortion or unevenness thereon at all

Good (Appearance was good): The surface had almost no distortion or unevenness thereon

Marginal (Appearance was somewhat poor): Distortion or unevenness was slightly observed on the surface

Poor (Appearance was poor): Distortion or unevenness was observed on the surface

### Pencil Hardness

The pencil hardness of the surface of the hard coat film (the surface of the hard coat layer) obtained above was evaluated according to JIS K5600-5-4, The pencil hardness was evaluated with a load of 750 g.

### Scratch Resistance

A #0000 steel wool was rubbed back and forth on the surface of the hard coat film (the surface of the hard coat layer) obtained above for a predetermined number of times described in Table 1 with a load of 1000 g/cm². The presence or absence of scratching on the surface was checked every 100 times to evaluate the scratch resistance.

OK: No scratching was observed at the predetermined number of times

NG: Scratching was observed at the predetermined number of times

### Example 1

Bonding of Hard Coat Film (First Film) to Surface Protection Film (Second Film) with Adhesive

The hard coat layer of the hard coat film obtained above as the first film and the adhesive layer of the surface protection film with an adhesive (trade name “NB0415”, thickness of the surface protection film: 38 μm, thickness of the adhesive layer: 24 μm, available from Fujimori Kogyo Co., Ltd.) as the second film were made to face each other, the first film and the second film were conveyed in the machine flow directions (MD) by a roll type laminator illustrated in FIG. 3, and both films were bonded to each other. A rubber roller having a surface made of rubber was used as a bonding roller that contacts the surface protection film having an adhesive, and a rubber roller having a surface made of rubber was also used as a bonding roller that contacts the hard coat film. Even though the hard coat film had a very high surface hardness with a pencil hardness of 9H, the hard coat film exhibited flexibility that did not generate cracks even when conveyed and bonded by the roll type laminator. The tension of each of the hard coat film and the surface protection film with an adhesive at the time of bonding was measured and controlled by a speed controlling-type tension controller. The tension (T₁) of the hard coat film (first film) was set to 1.25 N/mm², and the tension (T₂) of the surface protection film (second film) with an adhesive was set to 1.4 N/mm².

From the difference between T₂ and T₁, in the surface protection film, it is thought that an internal residual stress that is compressive with respect to the hard coat layer and that corresponds to (T₂−T₁=0.15 N/mm²) is present within the surface protection film of the surface protection film-adhered hard coat film (base material layer/hard coat layer/adhesive layer/surface protection film) obtained after bonding.

### Evaluation of Curling Amount

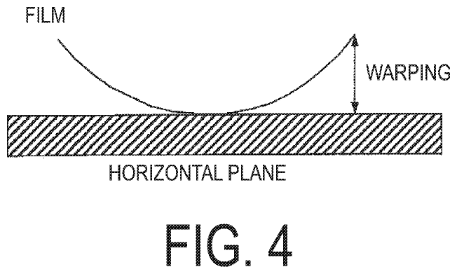

A rectangular test piece measuring 100×150 mm was cut from the obtained surface protection film-adhered hard coat film (base material layer/hard coat layer/adhesive layer/surface protection film) and was placed on a horizontal surface with the surface protection film side oriented downward. As the “warping (mm)” illustrated in FIG. 4, the curling amount at the four corners of the film (test piece) was measured after the test piece was left stationary for 12 hours under a condition of 23° C.—55% (curling when normal) and after the test piece was heated for 5 minutes at 120° C. (curling when heated at 120° C.), and the curling amount was evaluated as the average value thereof. When the film became tubular and the curling amount could not be measured, the film was considered to be “tubular”. The results are shown in Table 1.

Reverse curling was generated in the hard coat film of Example 1, and therefore it was confirmed that the cationic curable silicone resin produced in Synthesis Example 1 had a curing expansion property.

### Examples 2 and 3

A surface protection film-adhered hard coat film (base material layer/hard coat layer/adhesive layer/surface protection film) was prepared in the same manner as in Example 1 with the exception that the product shown in Table 1 was used as the surface protection film with an adhesive, and the curling amount was evaluated. The results are shown in Table 1.

### Comparative Example 1

Without being bonded together with a surface protection film, the hard coat film (base material layer/hard coat layer) obtained in Production Example 1 was placed on a horizontal surface with the hard coat layer oriented downward, and the curling amount was evaluated by the same method as Example 1. The results are shown in Table 1.

### Comparative Example 2

A surface protection film-adhered hard coat film (base material layer/hard coat layer/adhesive layer/surface protection film) was prepared in the same manner as in Example 1 with the exception that the tension (T₁) of the hard coat film (first film) was set to 1.25 N/mm² and that the tension (T₂) of the surface protection film (second film) with an adhesive was set to 1.25 N/mm² (T₂−T₁=0 N/mm²), and the curling amount was evaluated. The results are shown in Table 1.

TABLE 1

| | | | Comparative | Comparative | | | |
|---|---|---|---|---|---|---|---|
| | | | Example 1 | Example 2 | Example 1 | Example 2 | Example 3 |
| Curable | Cationic | Curable resin A | 61.6 | 61.6 | 61.6 | 61.6 | 61.6 |
| composition | curable | | | | | | |
| | silicone | | | | | | |
| | resin | | | | | | |
| | Epoxy | EHPE3150 | 6.9 | 6.9 | 6.9 | 6.9 | 6.9 |
| | compound | | | | | | |
| | Solvent | MIBK | 30 | 30 | 30 | 30 | 30 |
| | Photocationic | CPI-210S | | | | | |
| | polymerization | | 1 | 1 | 1 | 1 | 1 |
| | initiator | | | | | | |
| | Silicon | KRM8479 | 0.3 | 0.3 | 0.3 | 0.3 | 0.3 |
| | acrylate | | | | | | |
| | Silica | LPX22699 | 0.2 | 0.2 | 0.2 | 0.2 | 0.2 |
| | particles | | | | | | |
| Surface | NB0415 | Available from | | Present | Present | | |
| protection | (38 μm) | Fujimori Kogyo | | | | | |
| film with | KB003 | Co., Ltd. | | | | Present | |
| adhesive | (50 μm) | (thickness of | | | | | |
| | T001 | surface | | | | | |
| | (75 μm) | protection film) | | | | | Present |

| Hard coat | Thickness (μm) | 40 | 40 | 40 | 40 | 40 | |
|---|---|---|---|---|---|---|---|
| layer | | | | | | | |
| | Curling when normal 100 × | 33 mm | 32 mm | 21 mm | 19 mm | 4 | mm |
| | 150 mm size | | | | | | |
| | Curling when heated at 120° | Tubular | Tubular | 33 mm | 31 mm | 12 | mm |
| | C. 100 × 150 mm size | | | | | | |

| | | | | | |
|---|---|---|---|---|---|
| T₂ − T₁ (N/mm²) | — | 0 | 0.15 | 0.15 | 0.15 |

The abbreviations shown in Table 1 are as follows:

### Curable Composition

Curable Resin A: Cationic curable silicone resin (polyorganosilsesquioxane) obtained in Production Example 1

EHPE3150: 1,2-epoxy-4-(2-oxiranyl)cyclohexane adduct (product of the trade name “EHPE3150” (available from Daicel Corporation) of 2,2-bis(hydroxymethyl)-1-butanol

MIBK: Methyl isobutyl ketone (available from Kanto Chemical Co., Inc.)

CPI-210S: Photocationic polymerization initiator (product of the trade name “CPI-210 S”, available from San-Apro Ltd.)

KRM8479: Silicon acrylate (product of the trade name “KRM8479”, available from Daicel-Allnex Ltd.)

LPX 22699: Silica particles having a group containing a (meth)acryloyl group on the surface (product of the trade name “BYK-LPX 22699”, available from BYK Japan KK)

Surface Protection Film with Adhesive Layer

NB0415: Surface protection film with an adhesive (product of the trade name “NB0415”, PET film, thickness of surface protection film: 38 μm, thickness of adhesive layer: 24 μm, available from Fujimori Kogyo Co., Ltd.)

KB003: Surface protection film with adhesive (product of the trade name “KB003”, PET film, thickness of surface protection film: 50 μm, thickness of adhesive layer: 24 μm, available from Fujimori Kogyo Co., Ltd.)

T001: Surface protection film with adhesive (product of the trade name “TOO1”, PET film, thickness of surface production film: 75 μm, thickness of adhesive layer: 24 μm, available from Fujimori Kogyo Co., Ltd.)

Variations of embodiments of the present invention described above are additionally described below.

[1] A hard coat film, the hard coat film having a base material and a hard coat layer formed on one surface of the base material, wherein

an adhesive layer and a surface protection film are laminated in this order on the surface of the hard coat layer;

the hard coat layer is formed of a cured product of a curable composition, and the curable composition contains a curable compound having a curing expansion property; and

the surface protection film has an internal residual stress that is compressible with respect to the hard coat layer.

[2] The hard coat film according to [1], wherein a thickness of the hard coat film (total thickness of the base material layer/hard coat layer/adhesive layer/surface protection film layer) is from 1 to 10000 μm (preferably from 10 to 1000 μm, more preferably from 15 to 800 μm, even more preferably from 20 to 700 μm, and particularly preferably from 30 to 500 μm).

[3] The hard coat film according to [1] or [2], wherein the haze of the hard coat film is 1.5% or less (preferably 1.0% or less).

[4] The hard coat film according to any one of [1] to [3], wherein the total light transmittance of the hard coat film is 85% or greater (preferably 90% or greater).

[5] The hard coat film according to any one of [1] to [4], wherein a curling amount (curling when normal) in the hard coat film evaluated in the examples described above is 30 mm or less (preferably 10 mm or less).

[6] The hard coat film according to any one of [1] to [5], wherein a curling amount when heated at 120° C. in the hard coat film evaluated examples described above is 35 mm or less (preferably 15 mm or less).

[7] The hard coat film according to any one of [1] to [6], wherein a thickness of the hard coat layer is from 1 to 100 μm (preferably from 2 to 80 m, more preferably from 3 to 60 μm, even more preferably from 5 to 50 μm, and most preferably from 10 to 40 μm).

[8] The hard coat film according to any one of [1] to [7], wherein the pencil hardness of the hard coat layer surface is preferably H or greater (more preferably 2H or greater, even more preferably 3H or greater, particularly preferably 4H or greater, and most preferably 6H or greater).

[9] The hard coat film according to any one of [1] to [8], wherein the haze of the hard coat layer when the thickness thereof is 50 μm is 1.5% or less (preferably 1.0% or less).

[10] The hard coat film according to any one of [1] to [9], wherein the total light transmittance of the hard coat layer when the thickness thereof is 50 m is 85% or greater (preferably 90% or greater).

[11] The hard coat film according to any one of [1] to [10], wherein the hard coat layer is not scratched even when #0000 steel wool with a diameter of 1 cm is slid (rubbed) back and forth across the surface 100 times with a load of 1 kg/cm².

[12] The hard coat film according to any one of [1] to [11], wherein the arithmetic mean roughness Rₐ of the hard coat layer is from 0.1 to 20 nm (preferably from 0.1 to 10 nm and more preferably from 0.1 to 5 nm) in accordance with the method according to JIS B0601.

[13] The hard coat film according to any one of [1] to [12], wherein a water contact angle of the surface of the hard coat layer is 60° or greater (for example, from 60 to 1100, preferably from 70 to 1100, and more preferably from 80 to 1100).

[14] The hard coat film according to any one of [1] to [13], wherein a volume expansion percentage of the curable compound having a curing expansion property is from 0.01 to 30% (preferably from 0.01 to 10%) based on the uncured product.

[15] The hard coat film according to any one of [1] to [14], wherein the curable compound having a curing expansion property contains a cationic curable silicone resin.

[16] The hard coat film according to any one of [1] to [15], wherein the curable compound having a curing expansion property contains a cationic curable silicone resin, the cationic curable silicone resin contains a silsesquioxane unit, and a ratio of monomer units having an epoxy group to all monomer units is 50 mol % or greater (preferably from 55 to 100 mol %, more preferably from 65 to 99.9 mol %, even more preferably from 80 to 99 mol %, and particularly preferably from 90 to 99 mol %).

[17] The hard coat film according to [16], containing, as the silsesquioxane unit, a constituent unit represented by Formula (1) below, wherein a ratio of constituent units represented by Formula (1) to the total amount (100 mol %) of siloxane constituent units is 50 mol % or greater (preferably from 60 to 99 mol %, more preferably from 70 to 98 mol %, even more preferably from 80 to 95 mol %, and particularly preferably from 85 to 92 mol %).

[Chem. 20]

[R¹SiO_{3/2}] (1)

(In Formula (1), R¹ denotes: a group containing an epoxy group; a hydrogen atom; or a hydrocarbon group.)

[18] The hard coat film according to [17], wherein the group containing an epoxy group includes at least one type selected from the group consisting of a group containing a glycidyl group and a group containing an alicyclic epoxy group.

[19] The hard coat film according to [17] or [18], wherein R¹ in Formula (1) includes at least one group represented by Formulas (1a) to (1d) below.

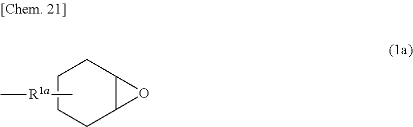

(In Formula (1a), R^{1a} denotes a linear or branched alkylene group.)

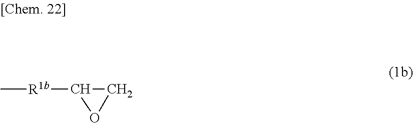

(In Formula (1b), R^{1b} denotes a linear or branched alkylene group.)

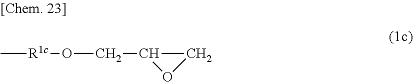

(In Formula (1c), R^{1c} denotes a linear or branched alkylene group.)

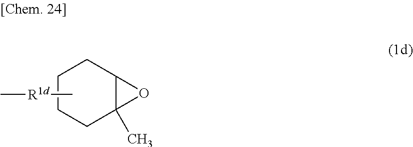

(In Formula (1d), R^{1d} denotes a linear or branched alkylene group.)

[20] The hard coat film according to [19], wherein R¹ in Formula (1) is a group represented by the above Formula (1a) in which R^{1a} is an ethylene group (among these, a 2-(3′,4′-epoxycyclohexyl)ethyl group).

[21] The hard coat film according to any one of [17] to [20], further containing, as the silsesquioxane unit, a constituent unit represented by formula (2) below, wherein a molar ratio of the constituent unit represented by formula (1) to the constituent unit represented by Formula (2) (constituent unit represented by Formula (1))/(constituent unit represented by Formula (2)) is 5 or greater (preferably from 5 to 18, more preferably from 6 to 16, and even more preferably from 7 to 14).

[Chem. 25]

[R¹SiO_{2/2}(OR²)] (2)

(In Formula (2), R¹ is the same as in Formula (1), and R² denotes a hydrogen atom or an alkyl group having from 1 to 4 carbons atoms.)

[22] The hard coat film according to any one of [15] to [21], wherein the cationic curable silicone resin includes a constituent unit represented by Formula (3) below and a constituent unit represented by Formula (4) below.

[Chem. 26]

[R³SiO_{3/2}] (3)

[Chem. 27]

[R⁴SiO_{3/2}] (4)

(R³ in Formula (3) is a group containing an alicyclic epoxy group, and R⁴ in Formula (4) is an aryl group (preferably a phenyl group) that may have a substituent.)

[23] The hard coat film according to [21] or [22], wherein a total ratio (total amount) of the constituent units represented by Formula (1) and the constituent units represented by Formula (2) with respect to a total amount (100 mol %) of the siloxane constituent units is from 55 to 100 mol % (preferably from 65 to 100 mol % and more preferably from 80 to 99 mol %).

[24] The hard coat film according to any one of [15] to [23], wherein the number average molecular weight of the cationic curable silicone resin is from 1000 to 3000 (preferably from 1000 to 2800 and more preferably 1100 to 2600).

[25] The hard coat film according to any one of [15] to [24], wherein a molecular weight dispersity (weight average molecular weight/number average molecular weight) of the cationic curable silicone resin is from 1.0 to 3.0 (preferably from 1.1 to 2.0, more preferably from 1.2 to 1.9, and even more preferably from 1.45 to 1.8).

[26] The hard coat film according to any one of [15] to [25], wherein a 5% weight loss temperature (T_{d5}) of the cationic curable silicone resin in an air atmosphere is 330° C. or higher (for example, from 330 to 450° C., preferably 340° C. or higher, and more preferably 350° C. or higher).

[27] The hard coat film according to any one of [15] to [26], wherein a content amount (compounded amount) of the cationic curable silicone resin in the curable composition is, per the total amount of the curable composition excluding the solvent, from 70 wt. % to less than 100 wt. % (preferably from 80 to 99.8 wt. % and more preferably from 90 to 99.5 wt. %).

[28] The hard coat film according to any one of [15] to [27], wherein the ratio of the cationic curable silicone resin to the total amount (100 wt %) of the cationic curable compound contained in the curable composition is from 70 to 100 wt. % (preferably from 75 to 98 wt. % and more preferably from 80 to 95 wt. %).

[29] The hard coat film according to any one of [1] to [28], wherein the curable composition includes an epoxy compound besides the cationic curable silicone resin (hereinafter, the epoxy compound thereof may be referred to simply as an “epoxy compound”).

[30] The hard coat film according to [29], wherein the epoxy compound is at least one type selected from the group consisting of alicyclic epoxy compounds, aromatic epoxy compounds, and aliphatic epoxy compounds (and is preferably an alicyclic epoxy compound).

[31] The hard coat film according to [30], wherein the alicyclic epoxy compound is at least one type selected from the group consisting of (1) a compound having an epoxy group (referred to as an “alicyclic epoxy group”) constituted of two adjacent carbon atoms and an oxygen atom that constitute an alicyclic ring in the molecule; (2) a compound in which an epoxy group is directly bonded to an alicyclic ring with a single bond; and (3) a compound having an alicyclic ring and a glycidyl ether group in the molecule.

[32] The hard coat film according to [31], wherein the compound (1) having an alicyclic epoxy group in the molecule is a compound represented by Formula (i) below.

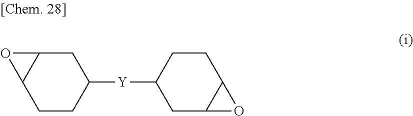

(In Formula (i) above, Y denotes a single bond or a linking group (a divalent group having one or more atoms)).

[33] The hard coat film according to [32], wherein the alicyclic epoxy compound represented by Formula (i) is at least one type selected from the group consisting of 3,4,3′,4′-diepoxy)bicyclohexyl, 2,2-bis(3,4-epoxycyclohexyl)propane, 1,2-bis(3,4-epoxycyclohexyl)ethane, 2,3-bis(3,4-epoxycyclohexyl)oxirane, bis(3,4-epoxycyclohexylmethyl)ether, and compounds represented by Formulas (i-1) to (i-10) below.

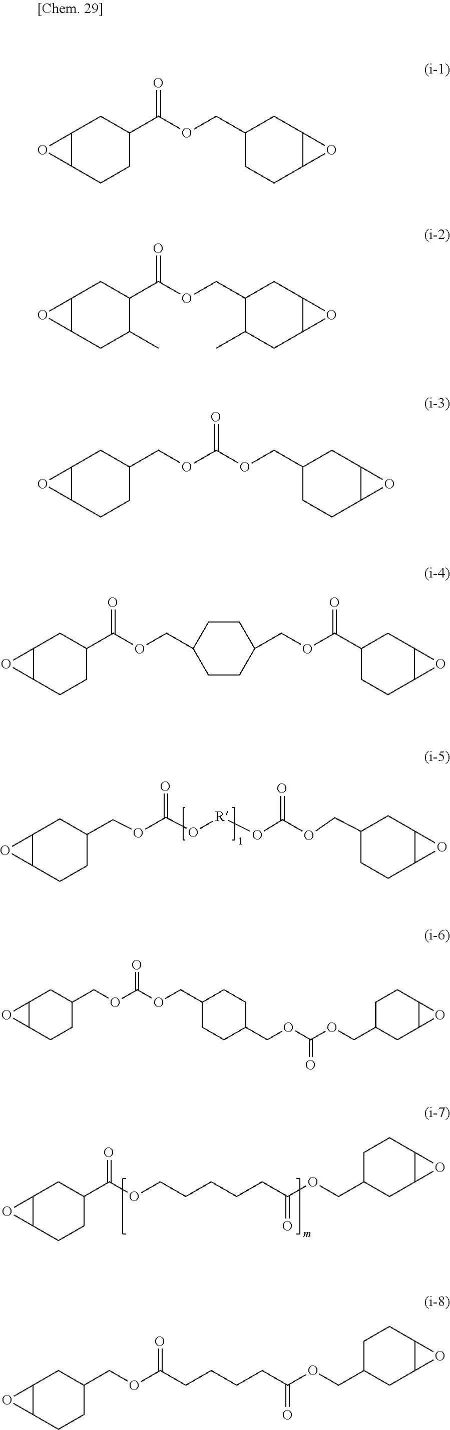

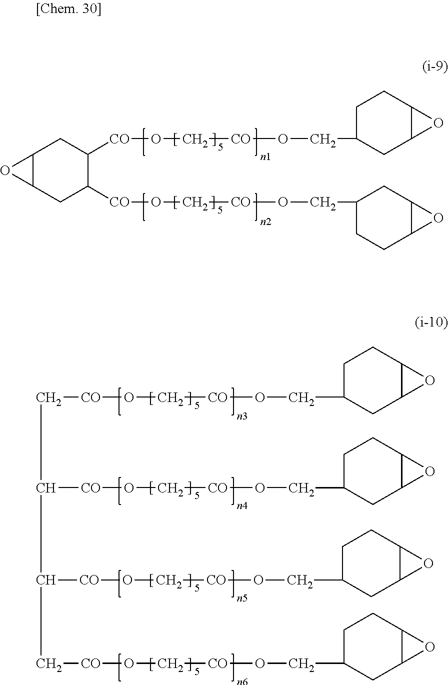

(In Formulas (i-5) and (i-7) above, 1 and m each represent an integer from 1 to 30. R′ in Formula (i-5) above represents an alkylene group having from 1 to 8 carbon atoms. In Formulas (i-9) and (i-10) above, n1 to n6 each represent an integer from 1 to 30.)

[34] The hard coat film according to any one of [31] to [33], wherein the compound (2) having an epoxy group bonded directly by a single bond to an alicyclic ring is a compound represented by Formula (ii) below.

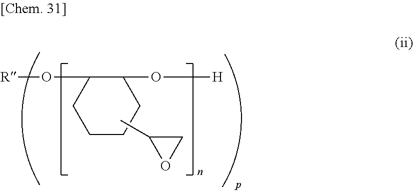

(In Formula (ii), R″ denotes a group (p-valent organic group) resulting from elimination of a quantity of p hydroxyl groups (—OH) from a structural formula of a p-hydric alcohol; wherein p and n each represent a natural number. When p is 2 or greater, n in each group in parentheses (in the outer parentheses) may be the same or different.)

[35] The hard coat film according to any one of [29] to [34], wherein the content amount (compounded amount) of the epoxy compound is from 0.5 to 100 parts by weight (preferably from 1 to 80 parts by weight and more preferably from 5 to 50 parts by weight), per the total amount of 100 parts by weight of the cationic curable silicone resin.

[36] The hard coat film according to any one of [1] to [35], wherein the curable composition contains a silicon acrylate (silicone acrylate).

[37] The hard coat film according to [36], wherein the ratio of the silicon acrylate is from 0.01 to 15 parts by weight (preferably from 0.05 to 10 parts by weight, more preferably from 0.01 to 5 parts by weight, and even more preferably from 0.2 to 3 parts by weight), per 100 parts by weight of the cationic curable silicone resin.

[38] The hard coat film according to any one of [1] to [37], wherein the curable composition contains silica particles having a group containing a (meth)acryloyl group on the surface.

[39] The hard coat film according to [38], wherein the particle size of the silica particles having a group containing a (meth)acryloyl group on the surface is from 1 to 100 nm (preferably from 3 to 50 nm and more preferably from 5 to 30 nm).

[40] The hard coat film according to [38] or [39], wherein a ratio of the silica particles having a group containing a (meth)acryloyl group on the surface thereof is from 0.01 to 20 parts by weight (preferably from 0.05 to 15 parts by weight, more preferably from 0.01 to 10 parts by weight, and even more preferably from 0.2 to 5 parts by weight), per 100 parts by weight of the cationic curable silicone resin.

[41] The hard coat film according to any one of [1] to [40], wherein the curable composition contains both a silicon acrylate; and silica particles having a group containing a (meth)acryloyl group on the surface.

[42] The hard coat film according to [41], wherein a total ratio of the silicon acrylate; and silica particles having a group containing a (meth)acryloyl group on the surface thereof is from 0.01 to 20 parts by weight (preferably from 0.05 to 15 parts by weight, more preferably from 0.01 to 10 parts by weight, and even more preferably from 0.2 to 5 parts by weight), per 100 parts by weight of the cationic curable silicone resin.

[43] The hard coat film according to any one of [1] to [42], wherein the curable composition contains a leveling agent.

[44] The hard coat film according to [43], wherein the leveling agent is at least one type selected from the group consisting of silicone-based leveling agents and fluorine-based leveling agents.

[45] The hard coat film according to [43] or [44], wherein the ratio of the leveling agent is from 0.01 to 10 parts by weight (preferably from 0.05 to 8 parts by weight, more preferably from 0.01 to 6 parts by weight, and even more preferably from 0.2 to 4 parts by weight), per 100 parts by weight of the cationic curable silicone resin.

[46] The hard coat film according to any one of [1] to [45], wherein the curable composition further contains a curing catalyst.

[47] The hard coat film according to [46], wherein the curing catalyst is a photocationic polymerization initiator.

[48] The hard coat film according to [46], wherein the curing catalyst is a thermal cationic polymerization initiator.

[49] The hard coat film according to any one of [46] to [48], wherein the content amount (compounded amount) of the curing catalyst is from 0.01 to 3.0 parts by weight (preferably from 0.05 to 3.0 parts by weight and more preferably from 0.1 to 1.0 parts by weight), per 100 parts by weight of the cationic curable silicone resin.

[50] The hard coat film according to any one of [1] to [49], wherein the base material is at least one type of plastic base material selected from the group consisting of polyester films (particularly, PET and PEN), cyclic polyolefin film, polycarbonate film, TAC film, and PMMA film.

[51] The hard coat film according to any one of [1] to [50], wherein a thickness of the base material is from 1 to 1000 μm (preferably from 5 to 500 m and most preferably from 25 to 80 μm).

[52] The hard coat film according to any one of [1] to [51], wherein a thickness of the adhesive layer is from 1 to 100 μm (preferably from 5 to 75 μm and most preferably from 10 to 50 μm).

[53] The hard coat film according to any one of [1] to [52], wherein the hard coat film has a roll shape, and the surface protection film has an internal residual stress that is compressible in the MD direction with respect to the hard coat layer.

[54] The hard coat film according to any one of [1] to [53], wherein the surface protection film contains a polyester resin (preferably polyethylene terephthalate).

[55] The hard coat film according to any one of [1] to [54], wherein a thickness of the surface protection film is from 25 to 250 μm (preferably from 26 to 188 μm and most preferably from 38 to 75 μm).

[56] A method for producing a hard coat film by bonding a below-described hard coat layer of a below-described first film to a below-described adhesive layer of a below-described second film,

a first film having a base material and a hard coat layer formed on one surface of the base material, wherein the hard coat layer is formed of a cured product of a curable composition, and the curable composition contains a curable compound having a curing expansion property,

a second film having a surface protection film and an adhesive layer formed on one surface of the surface protection film;

the production method for the hard coat film including:

conveying the first film and the second film in a state of being respectively tensioned, such that the hard coat layer of the first film and the adhesive layer of the second film are mutually facing; and

bonding the hard coat layer of the first film to the adhesive layer of the second film; wherein

the tension imparted to the second film is greater than the tension imparted to the first film.

[57] The method for producing a hard coat film according to [56], wherein the curable compound having a curing expansion property contains a cationic curable silicone resin, the cationic curable silicone resin contains a silsesquioxane unit, and a ratio of monomer units having an epoxy group to all monomer units is 50 mol % or greater.

[58] The method for producing a hard coat film according to [56] or [57], wherein the bending (bendability) of the first film is 30 mm or less (for example, from 1 to 30 mm, preferably 25 mm or less, more preferably 20 mm or less, and even more preferably 15 mm or less).

[59] The method for producing a hard coat film according to any one of [56] to [58], wherein a thickness of the first film is from 10 to 1000 μm (preferably from 15 to 800 μm, more preferably from 20 to 700 μm, and even more preferably from 30 to 500 μm).

[60] The method for producing a hard coat film according to any one of [56] to [59], wherein a magnitude (T₂) of the tension imparted to the second film is from 0.5 to 10 N/mm² (preferably from 1 to 5 N/mm²).

[61] The method for producing a hard coat film according to any one of [56] to [60], wherein a magnitude (T₁) of the tension imparted to the first film is from 0 to 3 N/mm² (preferably from 0.5 to 2 N/mm²).

[62] The method for producing a hard coat film according to any one of [56] to [61], wherein a ratio (T₂/T₁) of the magnitude (T₂) of tension imparted to the second film to the magnitude (T₁) of tension imparted to the first film is greater than 1 and less than or equal to 5 (preferably from 1.1 to 2).

[63] The method for producing a hard coat film according to any one of [56] to [62], wherein a difference (T₂−T₁) between the magnitude (T₂) of tension imparted to the second film and the magnitude (T₁) of tension imparted to the first film is from 0.1 to 5 N/mm² (preferably from 0.25 to 2.5 N/mm²).

[64] The method for producing a hard coat film according to any one of [56] to [63], wherein the production is performed with a roll-to-roll process.

[65] The method for producing a hard coat film according to [64], wherein tension is imparted in machine flow directions (MD directions) of the first film and the second film.

### INDUSTRIAL APPLICABILITY

With the hard coat film and method for producing the same of the present invention, the hard coat film that is provided suppresses curling and has high surface hardness, and therefore, the hard coat film of the present invention is suitable as a hard coat film that can be subjected to processing treatments such as edge printing and bonding of a circular polarizing plate.

### REFERENCE SIGNS LIST

1 Hard coat film
2 Surface protection film
3 Adhesive layer
4 Hard coat layer
5 Base material layer
6 Internal residual stress
7 Second film
8 First film
9 Tension imparted to the second film
10 Tension imparted to the first film
11 Hard coat film conveyance direction (MD direction)
12 Second film feeding roll
13 First film feeding roll
14 Bonding roller contacting second film
15 Bonding roller contacting first film
16 Winding roll for hard coat film
17 Second film conveyance direction (MD direction)
18 First film conveyance direction (MD direction)

1-18. (canceled)

19. A hard coat film, the hard coat film comprising:
a base material; and
a hard coat layer formed on one surface of the base material, wherein
an adhesive layer and a surface protection film are laminated in this order on the surface of the hard coat layer;
the hard coat layer is formed of a cured product of a curable composition, and the curable composition contains a curable compound having a curing expansion property; and
the surface protection film has an internal residual stress that is compressible with respect to the hard coat layer.

20. The hard coat film according to claim 19, wherein
the curable compound having a curing expansion property comprises a cationic curable silicone resin, the cationic curable silicone resin comprising a silsesquioxane unit, and
a ratio of monomer units having an epoxy group to all monomer units is 50 mol % or greater.

21. The hard coat film according to claim 19, wherein the surface protection film comprises a polyester resin.

22. The hard coat film according to claim 20 comprising, as the silsesquioxane unit, a constituent unit represented by Formula (1), wherein a ratio of constituent units represented by Formula (1) with respect to a total amount of siloxane constituent units (100 mol %) is 50 mol % or greater;
[R¹SiO_{3/2}] (1)
in Formula (1), R¹ denotes a group containing an epoxy group; a hydrogen atom; or a hydrocarbon group.

23. The hard coat film according to claim 22 further comprising, as the silsesquioxane unit, a constituent unit represented by Formula (2), wherein a molar ratio of the constituent unit represented by Formula (1) to the constituent unit represented by Formula (2), constituent unit represented by formula (1)/constituent unit represented by formula (2), is 5 or greater;
[R¹SiO_{2/2}(OR²)] (2)
in formula (2), R¹ is the same as in Formula (1), and R² denotes a hydrogen atom or an alkyl group having from 1 to 4 carbons atoms.

24. The hard coat film according to claim 23, wherein a total ratio (total amount) of the constituent units represented by Formula (1) and the constituent units represented by Formula (2) with respect to a total amount (100 mol %) of the siloxane constituent units is from 55 to 100 mol %.

25. The hard coat film according to claim 20, wherein a number average molecular weight of the cationic curable silicone resin is from 1000 to 3000.

26. The hard coat film according to claim 20, wherein a molecular weight dispersity, weight average molecular weight/number average molecular weight, of the cationic curable silicone resin is from 1.0 to 3.0.

27. The hard coat film according to claim 22, wherein R¹ in Formula (1) includes at least one group represented by Formulas (1a) to (1d) below; 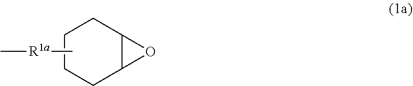
in Formula (1a), R^{1a} denotes a linear or branched alkylene group; 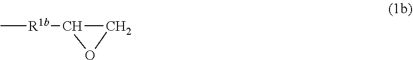
in Formula (1b), R^{1b} denotes a linear or branched alkylene group; 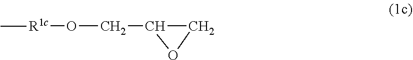
in Formula (1c), R^{1c} denotes a linear or branched alkylene group; 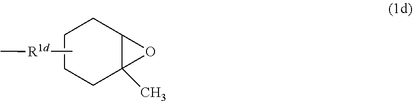
in formula (1d), R^{1d} denotes a linear or branched alkylene group.

28. The hard coat film according to claim 19, wherein the curable composition further comprises a curing catalyst.

29. The hard coat film according to claim 28, wherein the curing catalyst is a photocationic polymerization initiator.

30. The hard coat film according to claim 28, wherein the curing catalyst is a thermal cationic polymerization initiator.

31. The hard coat film according to claim 19, wherein a thickness of the hard coat layer is from 10 to 40 μm.

32. The hard coat film according to claim 19, wherein a thickness of the base material is from 25 to 80 μm.

33. A method for producing a hard coat film by bonding a below-described hard coat layer of a below-described first film to a below-described adhesive layer of a below-described second film,
a first film comprising a base material and a hard coat layer formed on one surface of the base material, wherein the hard coat layer is formed of a cured product of a curable composition, and the curable composition comprises a curable compound having a curing expansion property, and
a second film comprising a surface protection film and an adhesive layer formed on one surface of the surface protection film;
the production method for the hard coat film comprising:
conveying the first film and the second film in a state of being respectively tensioned, such that the hard coat layer of the first film and the adhesive layer of the second film are mutually facing; and
bonding the hard coat layer of the first film to the adhesive layer of the second film, wherein
the tension T₂ imparted to the second film is greater than the tension T₁ imparted to the first film, and
the difference (T₂−T₁) between the tension T₂ and the tension T₁ is from 0.1 to 5 N/mm².

34. The method for producing a hard coat film according to claim 33, wherein
the curable compound having a curing expansion property comprises a cationic curable silicone resin, the cationic curable silicone resin comprises a silsesquioxane unit, and
a ratio of monomer units having an epoxy group to all monomer units is 50 mol % or greater.

35. The method for producing a hard coat film according to claim 33, wherein the production is performed with a roll-to-roll process.

36. The method for producing a hard coat film according to claim 35, wherein tension is imparted in machine flow directions (MD directions) of the first film and the second film.
